(19) United States
(12) Patent Application Publication
(10) Pub. No.: US 2013/0253880 A1
(43) Pub. Date: Sep. 26, 2013

(54) Managing Power Consumption of a Device with a Gyroscope

(71) Applicants: Benjamin E. Joseph, Oakland, CA (US); Ian Chen, Campbell, CA (US); Debbie Meduna, Mountain View, CA (US)

(72) Inventors: Benjamin E. Joseph, Oakland, CA (US); Ian Chen, Campbell, CA (US); Debbie Meduna, Mountain View, CA (US)

(21) Appl. No.: 13/849,448

(22) Filed: Mar. 22, 2013

Related U.S. Application Data
(60) Provisional application No. 61/615,328, filed on Mar. 25, 2012.

(51) Int. Cl. G01C 19/00; G06F 17/00

(52) U.S. Cl. CPC G01C 19/00; G06F 17/00
USPC 702/150

(57) ABSTRACT

A processing apparatus having one or more processors and memory generates navigational state estimates for a device having a gyroscope. The processing apparatus has a gyroscope-assisted mode of operation in which measurements from the gyroscope are used to estimate the navigational states and an alternate mode of operation in which measurements from other sensors are used to estimate the navigational state of the device. For a first time period and a subsequent transition time period, the processing apparatus estimates the navigational state of the device without sensor measurements from the gyroscope. At an end of the transition time period, the processing apparatus starts to use measurements from the gyroscope to estimate the navigational state of the device. For a second time period, after the transition time period, the processing apparatus estimates the navigational state of the device using sensor measurements from the gyroscope.

### RELATED APPLICATIONS

This application claims priority to U.S. Provisional Application Ser. No. 61/615,328, filed Mar. 25, 2012, which application is incorporated by reference herein in its entirety.

### TECHNICAL FIELD

The disclosed embodiments relate generally to determining a navigational state of a navigation sensing device.

### BACKGROUND

A navigation sensing device detects changes in navigational state of the device using one or more sensors. In some situations sensor measurements from multiple sensors are combined to determine a navigational state of the sensing device. The navigational state of the device can be used for many different purposes, including controlling a user interface (e.g., moving a mouse cursor) and tracking movements of the navigation sensing device over time.

### SUMMARY

Gyroscopes are frequently used as sensors for navigation sensing devices. However, many gyroscopes draw a large amount of power as compared with other sensors that are used in navigation sensing devices. For example, a typical gyroscope may draw ten times as much power as an alternative set of sensors that can be used to generate navigational state estimates (e.g., a combination of one or more magnetometers and one or more accelerometers). While the use of a gyroscope can substantially improve the accuracy of navigational state determination for a navigation sensing device, the continuous use of a gyroscope increases the power use for a device. For navigation sensing devices that use batteries and other power storage solutions that have a finite capacity, the extra power drain generated by a gyroscope can dramatically reduce operation time between refreshing the power source (e.g., recharging/replacing the battery). Thus, it is advantageous, in many situations to reduce power usage of the gyroscope (e.g., by turning the gyroscope off) when gyroscope sensor measurements are not needed (e.g., when the device is not moving or high-fidelity navigational state estimates are not needed).

While turning the gyroscope off or setting the gyroscope to a low power mode conserves power usage and prolongs battery life of the device, many gyroscopes such as micoelectromechanical system (MEMS) gyroscopes take a noticeable amount of time (e.g., up to 250 ms) to warm up and begin generating useable sensor measurements. This warm up time for gyroscopes, in turn, can create a delay in generating navigational state estimates if the gyroscope sensor measurements are necessary for the navigational state to be estimated. As such, it would be advantageous to have a navigation sensing device that is able to selectively transition a gyroscope into low power mode to conserve power but still be able to produce navigational state estimates before the gyroscope has warmed up. Additionally, in some situations the gyroscope serves as an additional sensor that can be used to maintain the accuracy of a navigational state estimate for a navigation sensing device when one or more other sensors (e.g., magnetometers or accelerometers) of the device are not able to produce reliable sensor measurements. Thus, it would also be advantageous to determine situations under which it is preferable not to transition the gyroscope to a low-power state so as to maintain a desired degree of accuracy navigational state estimates for the device.

Some embodiments provide a method for, at a processing apparatus having one or more processors and memory storing one or more programs that when executed by the one or more processors cause the respective processing apparatus to perform the method. The method includes generating navigational state estimates for a device having a plurality of sensors. The plurality of sensors includes a gyroscope. The processing apparatus has a plurality of modes of operation including: a gyroscope-assisted mode of operation in which measurements from the gyroscope are used to estimate the navigational state of the device and an alternate mode of operation in which measurements from a subset of sensors of the plurality of sensors that does not include the gyroscope are used to estimate the navigational state of the device. For a first time period and a subsequent transition time period, the method further includes operating in the alternate mode of operation using measurements from a subset of sensors of the plurality of sensors that does not include the gyroscope to estimate the navigational state of the device and at an end of the transition time period, starting to use measurements from the gyroscope to estimate the navigational state of the device. The method also includes, for a second time period, which occurs after the transition time period, operating in the gyroscope-assisted mode of operation using measurements the plurality of sensors, including the gyroscope, to estimate the navigational state of the device.

Some embodiments provide a method for, at a processing apparatus having one or more processors and memory storing one or more programs that when executed by the one or more processors cause the respective processing apparatus to perform the method. The method includes generating navigational state estimates for a device having a plurality of sensors. The plurality of sensors includes a gyroscope that takes at least a minimum amount of time to transition from a low-power state to a measurement-generation state. The method further includes, while the gyroscope is in the measurement-generation state, determining that the estimate of the navigational state of the device does not need to be updated. The method also includes, after determining that the estimate of the navigational state of the device does not need to be updated, determining whether a subset of sensors of the plurality of sensors that does not include the gyroscope provides sensor measurements that enable the estimate of the navigational state of the device to be accurately updated in a current operating environment of the device. The method also includes, in accordance with a determination that the subset of sensors provides sensor measurements that enable the estimate of the navigational state of the device to be accurately updated in the current operating environment of the device, transitioning the gyroscope from the measurement-generation state to the low-power state. The method further includes, in accordance with a determination that the subset of sensors does not provide sensor measurements that enable the estimate of the navigational state of the device to be accurately updated in the current operating environment of the device, maintaining the gyroscope in the measurement-generation state.

In accordance with some embodiments, a computer system (e.g., a navigation sensing device or a host computer system) includes one or more processors, memory, and one or more programs; the one or more programs are stored in the memory and configured to be executed by the one or more processors and the one or more programs include instructions for performing the operations of any of the methods described above. In accordance with some embodiments, a non-transitory computer readable storage medium (e.g., for use by a navigation sensing device or a host computer system) has stored therein instructions which when executed by one or more processors, cause a computer system (e.g., a navigation sensing device or a host computer system) to perform the operations of any of the methods described above.

### BRIEF DESCRIPTION OF THE DRAWINGS

FIG. 1 illustrates a system for using a navigation sensing device, according to some embodiments.

FIG. 2 is a block diagram illustrating an example navigation sensing device, according to some embodiments.

FIGS. 3A-3E are block diagrams illustrating configurations of various components of the system including a navigation sensing device, according to some embodiments.

FIGS. 4A-4B are diagrams illustrating examples of switching between modes of operation, according to some embodiments.

FIG. 5 is a block diagram illustrating examples of using sensor measurements to update an estimate of a navigational state of a navigation device, according to some embodiments.

FIGS. 6A-6C are flow diagrams of a method for determining estimated navigational states of a navigation sensing device, according to some embodiments.

FIGS. 7A-7B are flow diagrams of a method for determining estimated navigational states of a navigation sensing device, according to some embodiments.

FIG. 8 presents a block diagram of an example navigation sensing device, according to some embodiments.

FIG. 9 presents a block diagram of an example host computer system, according to some embodiments.

Like reference numerals refer to corresponding parts throughout the drawings.

### DESCRIPTION OF EMBODIMENTS

### Exemplary Use Cases

Navigation sensing devices (e.g., human interface devices or motion tracking device) that have a determinable multi-dimensional navigational state (e.g., one or more dimensions of displacement and/or one or more dimensions of rotation or attitude) are becoming increasingly common for providing input for many different applications. For example, such a navigation sensing device may be used as a multi-dimensional pointer to control a pointer (e.g., a cursor) on a display of a personal computer, television, gaming system, etc. As another example, such a navigation sensing device may be used to provide augmented reality views (e.g., by overlaying computer generated elements over a display of a view of the real world) that change in accordance with the navigational state of the navigation sensing device so as to match up with a view of the real world that is detected on a camera attached to the navigation sensing device. As yet another example, such a navigation sensing device may be used to provide views of a virtual world (e.g., views of portions of a video game, computer generated simulation, etc.) that change in accordance with the navigational state of the navigation sensing device so as to match up with a virtual viewpoint of the user based on the orientation of the device. In other situations a navigation sensing device may be used as a motion tracking device to track changes in position and/or orientation of the device over time. These tracked changes can be used to map movements and/or provide other navigational state dependent services (e.g., location or orientation based alerts, etc.). In this document, the terms orientation, attitude and rotation are used interchangeably to refer to the orientation of a device or object with respect to a frame of reference.

In order to function properly (e.g., return results to the user that correspond to movements of the navigation sensing device in predictable ways), these applications rely on sensors that determine accurate estimates of the navigational state of the device. While specific use cases are described above and will be used to illustrate the general concepts described herein, it should be understood that these examples are non-limiting examples and that the embodiments described herein would apply in an analogous manner to any navigation sensing device that would benefit from an accurate estimate of the navigational state of the device.

### System Overview

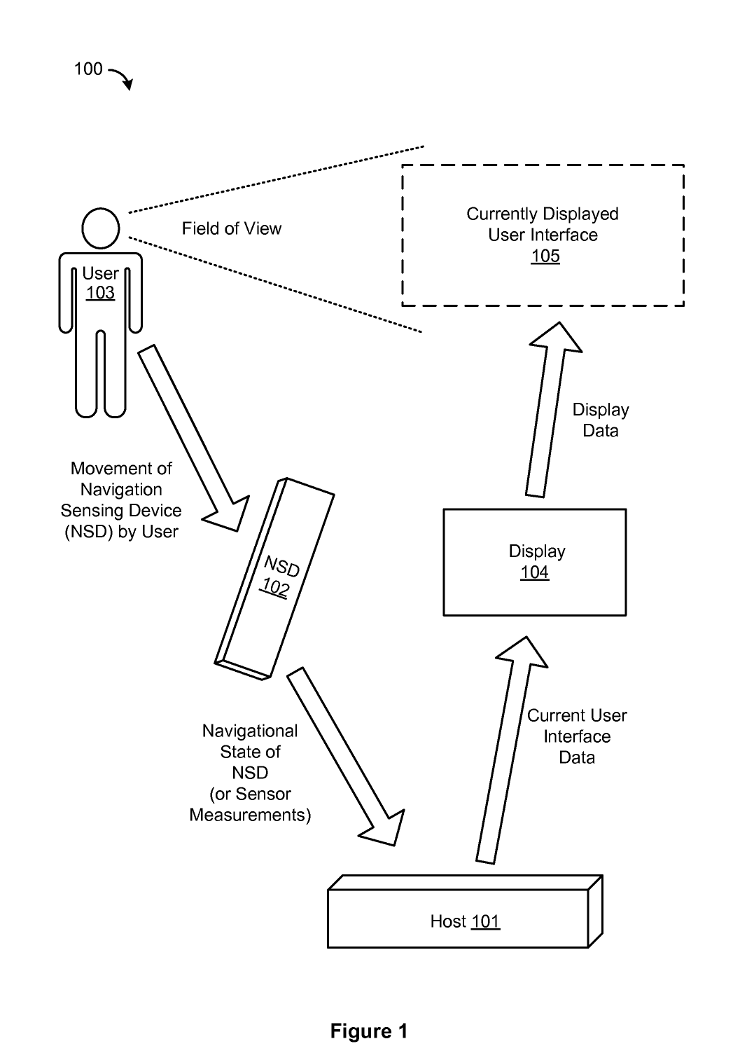

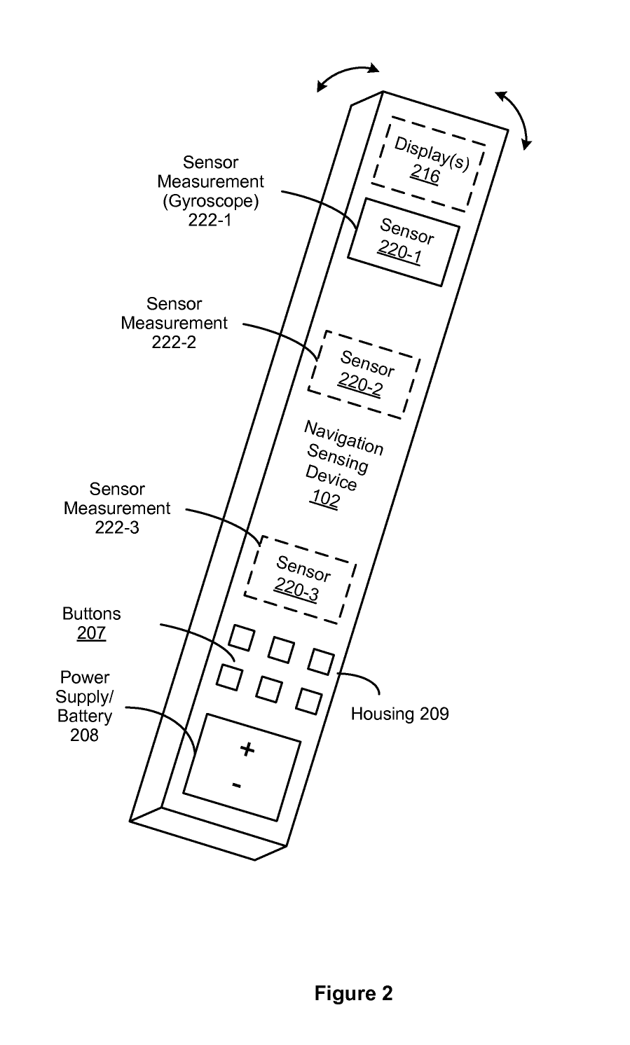

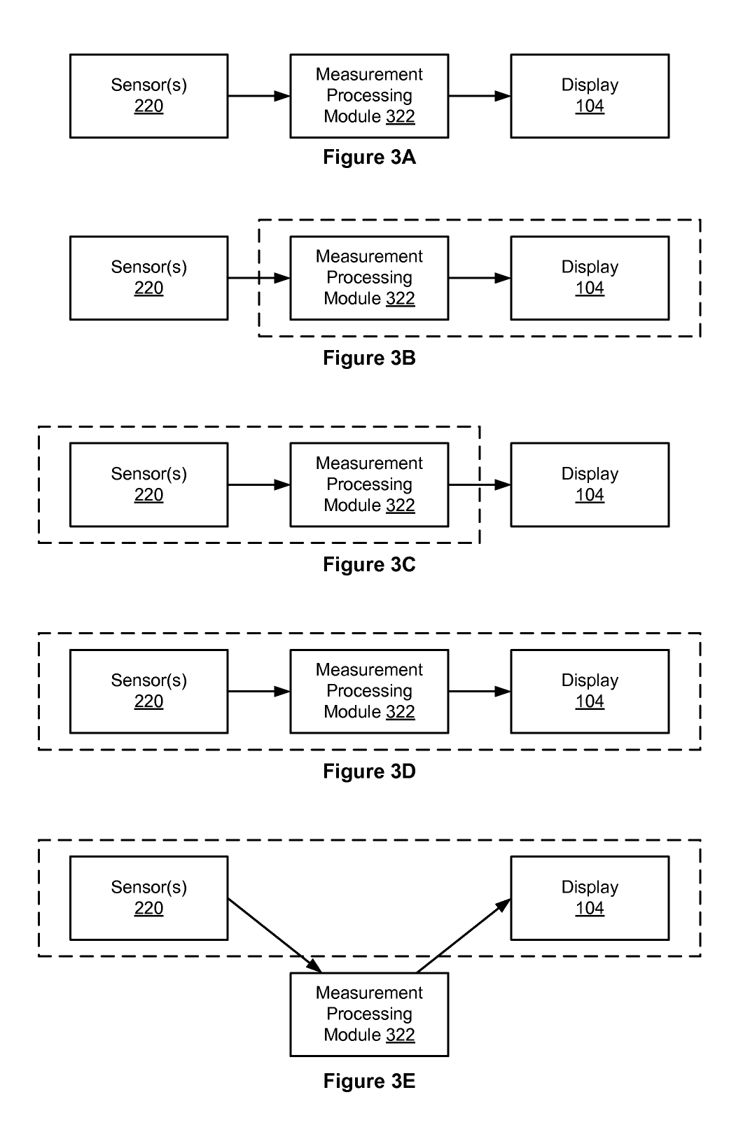

Attention is now directed to FIG. 1, which illustrates an example system 100 for using a navigation sensing device (e.g., a human interface device such as a multi-dimensional pointer) to manipulate a user interface. As shown in FIG. 1, an example Navigation Sensing Device 102 (hereinafter “Device 102”) is coupled to a Host Computer System 101 (hereinafter “Host 101”) through a wireless interface, according to some embodiments. In these embodiments, a User 103 moves Device 102. These movements are detected by sensors in Device 102, as described in greater detail below with reference to FIG. 2. Device 102, or Host 101, generates a navigational state of Device 102 based on sensor measurements from the sensors and transmits the navigational state to Host 101. Alternatively, Device 102 generates sensor measurements and transmits the sensor measurements to Host 101, for use in estimating a navigational state of Device 102. Host 101 generates current user interface data based on the navigational state of Device 102 and transmits the current user interface data to Display 104 (e.g., a display or a projector), which generates display data that is displayed to the user as the currently displayed User Interface 105. While Device 102, Host 101 and Display 104 are shown in FIG. 1 as being separate, in some embodiments the functions of one or more of these elements are combined or rearranged, as described in greater detail below with reference to FIGS. 3A-3E.

Thus, the user can use Device 102 to issue commands for modifying the user interface, control objects in the user interface, and/or position objects in the user interface by moving Device 102 so as to change its navigational state. In some embodiments, Device 102 is sensitive to six degrees of freedom: displacement along the x-axis, displacement along the y-axis, displacement along the z-axis, yaw, pitch, and roll.

In some other situations, Device 102 is a navigational state tracking device (e.g., a motion tracking device) that tracks changes in the navigational state of Device 102 over time but does not use these changes to directly update a user interface that is displayed to the user. For example, the updates in the navigational state can be recorded for later use by the user or transmitted to another user or can be used to track movement of the device and provide feedback to the user concerning their movement (e.g., directions to a particular location near the user based on an estimated location of the user). When used to track movements of a user without relying on external location information (e.g., Global Positioning System signals), such motion tracking devices are also sometimes referred to as pedestrian dead reckoning devices.

In some embodiments, the wireless interface is selected from the group consisting of: a Wi-Fi interface, a Bluetooth interface, an infrared interface, an audio interface, a visible light interface, a radio frequency (RF) interface, and any combination of the aforementioned wireless interfaces. In some embodiments, the wireless interface is a unidirectional wireless interface from Device 102 to Host 101. In some embodiments, the wireless interface is a bidirectional wireless interface. In some embodiments, bidirectional communication is used to perform handshaking and pairing operations. In some embodiments, a wired interface is used instead of or in addition to a wireless interface. As with the wireless interface, the wired interface may be a unidirectional or bidirectional wired interface.

In some embodiments, data corresponding to a navigational state of Device 102 (e.g., raw measurements, calculated attitude, correction factors, position information, etc.) is transmitted from Device 102 and received and processed on Host 101 (e.g., by a host side device driver). Host 101 uses this data to generate current user interface data (e.g., specifying a position of a cursor and/or other objects in a user interface) or tracking information.

Attention is now directed to FIG. 2, which illustrates an example of Device 102, according to some embodiments. In accordance with some embodiments, Device 102 includes one or more Sensors 220 which produce corresponding sensor outputs, which can be used to determine a navigational state of Device 102. For example, in one implementation, Sensor 220-1 is a gyroscope generating measurements (e.g., either a rotational vector measurement or rotational rate vector measurement) corresponding to changes in orientation of the device, Sensor 220-2 is a multi-dimensional accelerometer generating multi-dimensional accelerometer measurements (e.g., a rotation and translation measurement), and Sensor 220-3 is a multi-dimensional magnetometer generating multi-dimensional magnetometer measurements (e.g., a rotation measurement). In some implementations Sensors 220 include one or more of gyroscopes, beacon sensors, inertial measurement units, temperature sensors, barometers, proximity sensors, single-dimensional accelerometers and multi-dimensional accelerometers instead of or in addition to the multi-dimensional magnetometer and multi-dimensional accelerometer and gyroscope described above.

In some embodiments, Device 102 also includes one or more of: Buttons 207, Power Supply/Battery 208, Camera 214 and/or Display 216 (e.g., a display or projector). In some embodiments, Device 102 also includes one or more of the following additional user interface components: one or more processors, memory, a keypad, one or more thumb wheels, one or more light-emitting diodes (LEDs), an audio speaker, an audio microphone, a liquid crystal display (LCD), etc. In some embodiments, the various components of Device 102 (e.g., Sensors 220, Buttons 207, Power Supply 208, Camera 214 and Display 216) are all enclosed in Housing 209 of Device 102. However, in implementations where Device 102 is a pedestrian dead reckoning device, many of these features are not necessary, and Device 102 can use Sensors 220 to generate tracking information corresponding changes in navigational state of Device 102 and transmit the tracking information to Host 101 wirelessly or store the tracking information for later transmission (e.g., via a wired or wireless data connection) to Host 101.

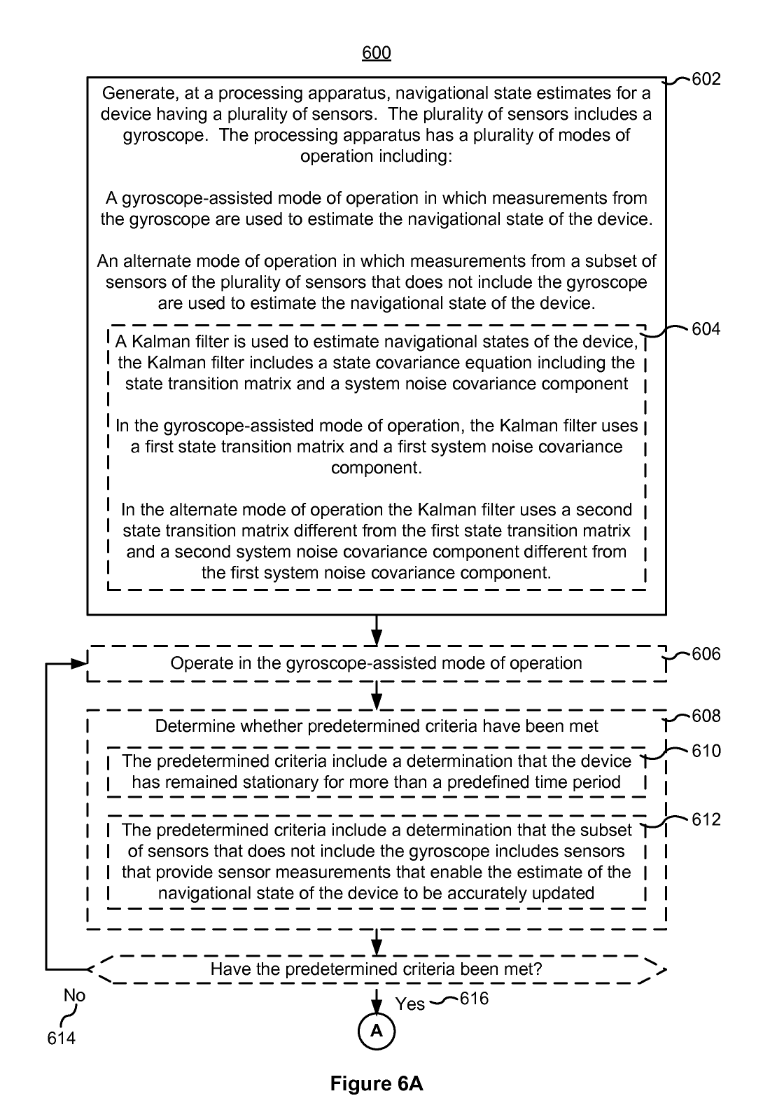

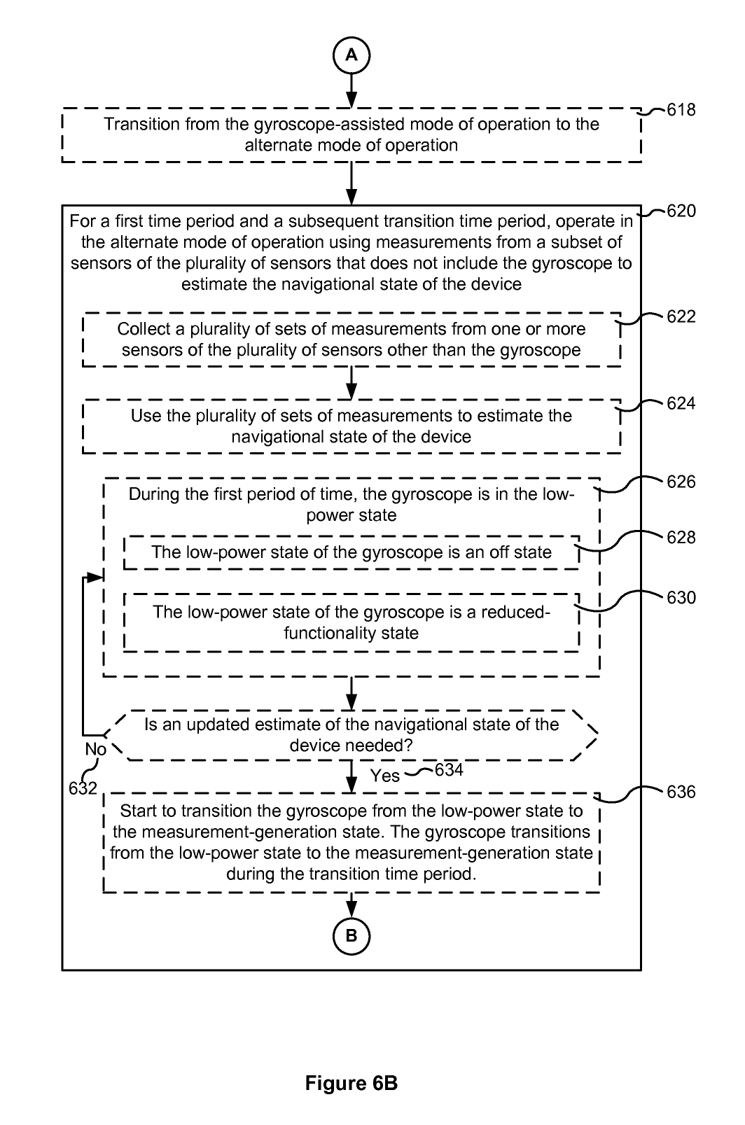

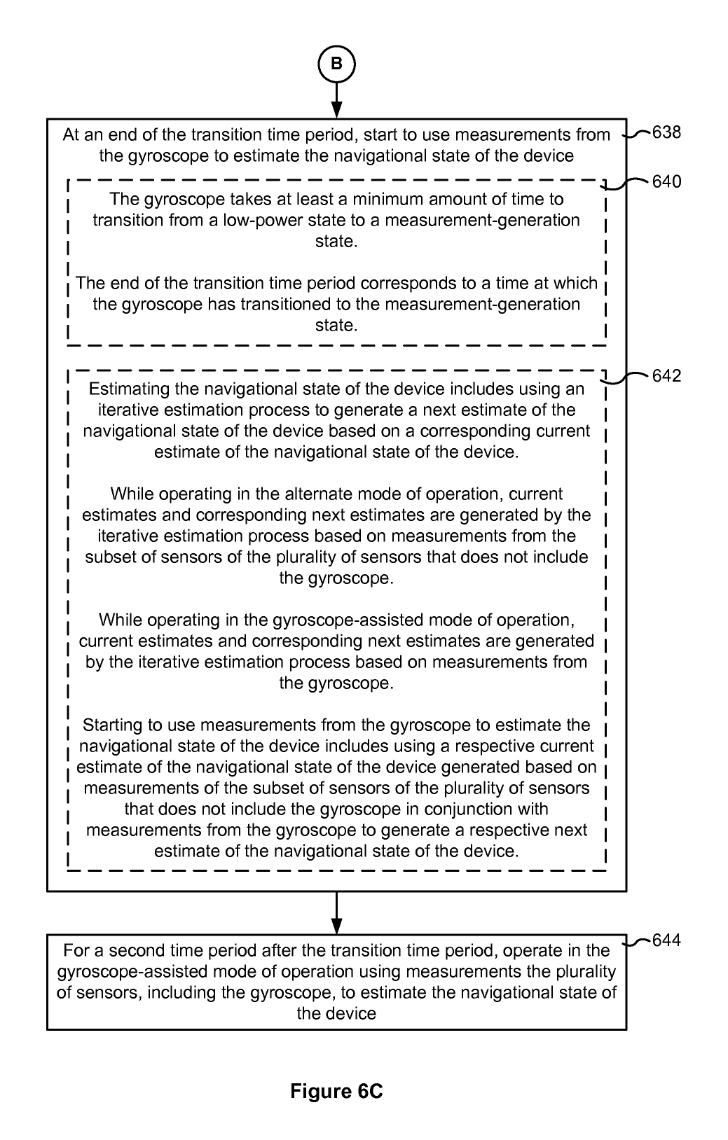

In some embodiments, one or more processors (e.g., 1102, FIG. 6) of Device 102 perform one or more of the following operations: sampling Sensor Measurements 222, at a respective sampling rate, produced by Sensors 220; processing sampled data to determine displacement; transmitting displacement information to Host 101; monitoring the battery voltage and alerting Host 101 when the charge of Battery 208 is low; monitoring other user input devices (e.g., keypads, buttons, etc.), if any, on Device 102 and, as appropriate, transmitting information identifying user input device events (e.g., button presses) to Host 101; continuously or periodically running background processes to maintain or update calibration of Sensors 220; providing feedback to the user as needed on the remote (e.g., via LEDs, etc.); and recognizing gestures performed by user movement of Device 102.

Attention is now directed to FIGS. 3A-3E, which illustrate configurations of various components of the system for generating navigational state estimates for a navigation sensing device. In some embodiments, there are three fundamental components to the system for determining a navigational state of a navigation sensing device described herein: Sensors 220, which provide sensor measurements that are used to determine a navigational state of Device 102, Measurement Processing Module 322 (e.g., a processing apparatus including one or more processors and memory) which uses the sensor measurements generated by one or more of Sensors 220 to generate estimates of the navigational state of Device 102 which can be used to determine current user interface data and/or track movement of Device 102 over time, and, optionally, Display 104, which displays the currently displayed user interface to the user of Device 102 and/or information corresponding to movement of Device 102 over time. It should be understood that these components can be distributed among any number of different devices.

In some embodiments, Measurement Processing Module 322 (e.g., a processing apparatus including one or more processors and memory) is a component of the device including Sensors 220. In some embodiments, Measurement Processing Module 322 (e.g., a processing apparatus including one or more processors and memory) is a component of a computer system that is distinct from the device including Sensors 220. In some embodiments a first portion of the functions of Measurement Processing Module 322 are performed by a first device (e.g., raw sensor data is converted into processed sensor data at Device 102) and a second portion of the functions of Measurement Processing Module 322 are performed by a second device (e.g., processed sensor data is used to generate a navigational state estimate for Device 102 at Host 101).

As one example, in FIG. 3A, Sensors 220, Measurement Processing Module 322 and Display 104 are distributed between three different devices (e.g., a navigation sensing device such as a multi-dimensional pointer, a set top box, and a television, respectively; or a motion tracking device, a backend motion processing server and a motion tracking client). As another example, in FIG. 3B, Sensors 220 are included in a first device (e.g., a multi-dimensional pointer or a pedestrian dead reckoning device), while the Measurement Processing Module 322 and Display 104 are included in a second device (e.g., a host with an integrated display). As another example, in FIG. 3C, Sensors 220 and Measurement Processing Module 322 are included in a first device, while Display 104 is included in a second device (e.g., a “smart” multi-dimensional pointer and a television respectively; or a motion tracking device and a display for displaying information corresponding to changes in the movement of the motion tracking device over time, respectively).

As yet another example, in FIG. 3D, Sensors 220, Measurement Processing Module 322 and Display 104 are included in a single device (e.g., a mobile computing device, such as a smart phone, personal digital assistant, tablet computer, etc., with an augmented reality application). As a final example, in FIG. 3E, Sensors 220 and Display 104 are included in a first device (e.g., a game controller with a display/projector), while Measurement Processing Module 322 is included in a second device (e.g., a game console/server). It should be understood that in the example shown in FIG. 3E, the first device will typically be a portable device (e.g., a smartphone or a pointing device) with limited processing power, while the second device is a device (e.g., a host computer system) with the capability to perform more complex processing operations, or to perform processing operations at greater speed, and thus the computationally intensive calculations are offloaded from the portable device to a host device with greater processing power. While a plurality of common examples have been described above, it should be understood that the embodiments described herein are not limited to the examples described above, and other distributions of the various components could be made without departing from the scope of the described embodiments.

### Intelligently Reducing Device Power Consumption

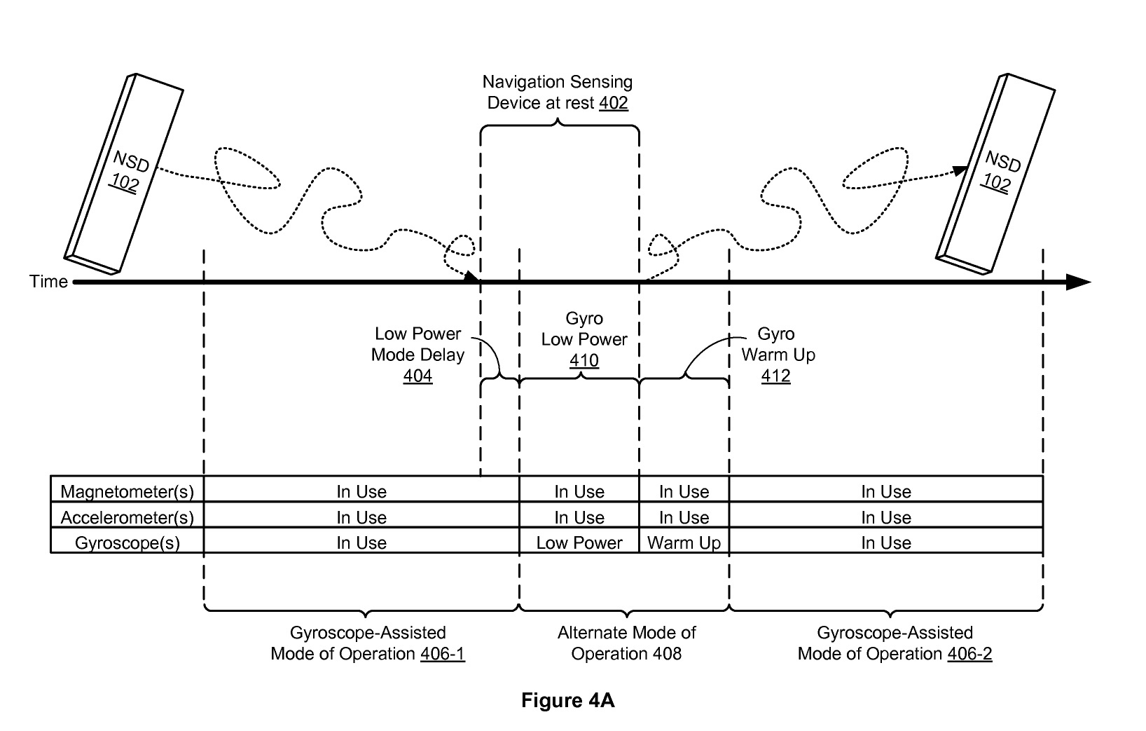

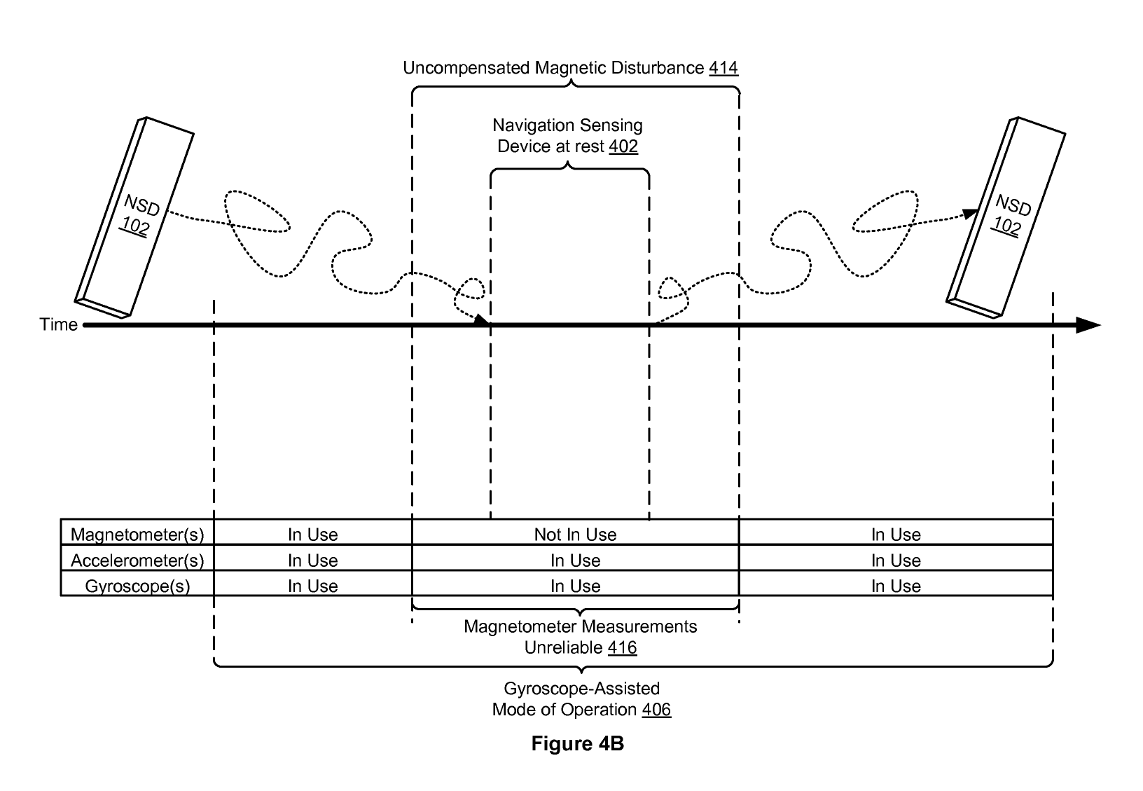

As shown in FIG. 4A, over a period of time Device 102 moves and sensor measurements from a plurality of sensors are obtained so as to generate navigational state estimates for Device 102. At some point over the period of time, Device 102 is at rest 402. In some embodiments, there is a predefined delay (e.g., Low Power Mode Delay 404) before Device 102 responds to the determination that Device 102 is at rest by setting a gyroscope to a low power mode. Prior to detecting that Device 102 is at rest (and optionally during the Low Power Mode Delay 404), a processing apparatus that determines navigational state estimates for Device 102 is in a Gyroscope-Assisted Mode of Operation 406-1, where the gyroscope is in a measurement-generation state and sensor measurements from a gyroscope of Device 102 are used to generate navigational state estimates. When Device 102 is still at rest (e.g., after a time period corresponding to Low Power Mode Delay 404 has elapsed) the processing apparatus transitions to Alternate Mode of Operation 408. In Alternate Mode of Operation 408, the gyroscope is in a Low Power 410 state (e.g., off or in a reduced functionality state) and the processing apparatus does not receive gyroscope sensor measurements. Thus, in Alternate Mode of Operation 408, the processing apparatus relies on other sensors (e.g., one or more magnetometers and one or more accelerometers) to determine a navigational state estimates for Device 102, because sensor measurements from the gyroscope are not available.

Subsequently, movement of Device 102 resumes, and the processing apparatus determines that updated navigational state estimates for Device 102 are needed. Thus, the processing apparatus begins to transition back to Gyroscope-Assisted Mode of Operation 406-2, which includes transitioning the gyroscope back into a normal (e.g., measurement-generating) operating state (e.g., turning the gyroscope on or switching from the reduced functionality state) where gyroscope sensor measurements are provided to the processing apparatus for use in determining navigational state estimates for Device 102. However, in the example shown in FIG. 4A, the gyroscope has a non-zero warm-up time before it has transitioned to the normal (e.g., measurement-generating) operation state. Thus, for a transition time period, the Gyroscope is Warming Up 412. After the gyroscope has warmed up, the processing apparatus switches to Gyroscope-Assisted Mode of Operation 406-2.

In some situations, ceasing to use measurements from the gyroscope to generate navigational state estimates will dramatically reduce the accuracy of navigational state estimates produced by the processing apparatus. For example, in some implementations the alternative sensors that are used while the gyroscope is not in use include a magnetometer and an accelerometer. In such implementations, if there is an uncompensated magnetic disturbance (e.g., a non-uniform magnetic disturbance that cannot easily be corrected for or a magnetic disturbance of unknown size/direction), the magnetometer will not be useful for accurately determining changes to orientation of Device 102. As shown in FIG. 4B, even though Device 102 moves and ceases movement in substantially the same way as Device 102 in FIG. 4A, during the time that Navigation Sensing Device 402 is at rest, there is a magnetic disturbance (e.g., Uncompensated Magnetic Disturbance 414) that changes how the processing apparatus decides to switch modes of operation. While Uncompensated Magnetic Disturbance 414 is detected, Magnetometer Measurements from the magnetometer(s) are Unreliable 416. As such, the magnetometer measurements from the magnetometer(s) are not used to determine changes to navigational state estimates for Device 102 while Uncompensated Magnetic Disturbance 414 is detected. Thus, even though Device 102 is at rest for a particular time period (e.g., Navigation Sensing Device at Rest 402), the processing apparatus remains in Gyroscope-Assisted Mode of Operation 406, as sensor measurements from the gyroscope are needed to ensure the accuracy of navigational state estimates of Device 102 while there is an uncompensated magnetic disturbance.

By choosing not to transition to the alternate mode of operation while Uncompensated Magnetic Disturbance 414 is detected, processing apparatus avoids potential inaccuracy of the navigational state estimates that would have resulted if the gyroscope had switched to a low-power state (e.g., an off state or a reduced-functionality state). For example, relying on a combination of one or more accelerometers and one or more magnetometers can be problematic if Device 102 is made still and turns off its gyroscope(s) in a distorted (e.g., non-uniform) magnetic field. When updated navigational state estimates for Device 102 are needed (e.g., because motion of the device has resumed), if Device 102 is an a distorted magnetic field, the rotation estimate provided by the magnetic field will not match the rotation estimate that would have been generated by the gyroscope had it been in a measurement-generation state when the motion of Device 102 resumed. In this situation, the gyroscope's estimate would have been superior. Consequently, in this situation, it is preferable not to transition the gyroscope to a low-power state if Device 102 ceases movement in a distorted magnetic field that includes an uncompensated magnetic disturbance, as shown in FIG. 4B.

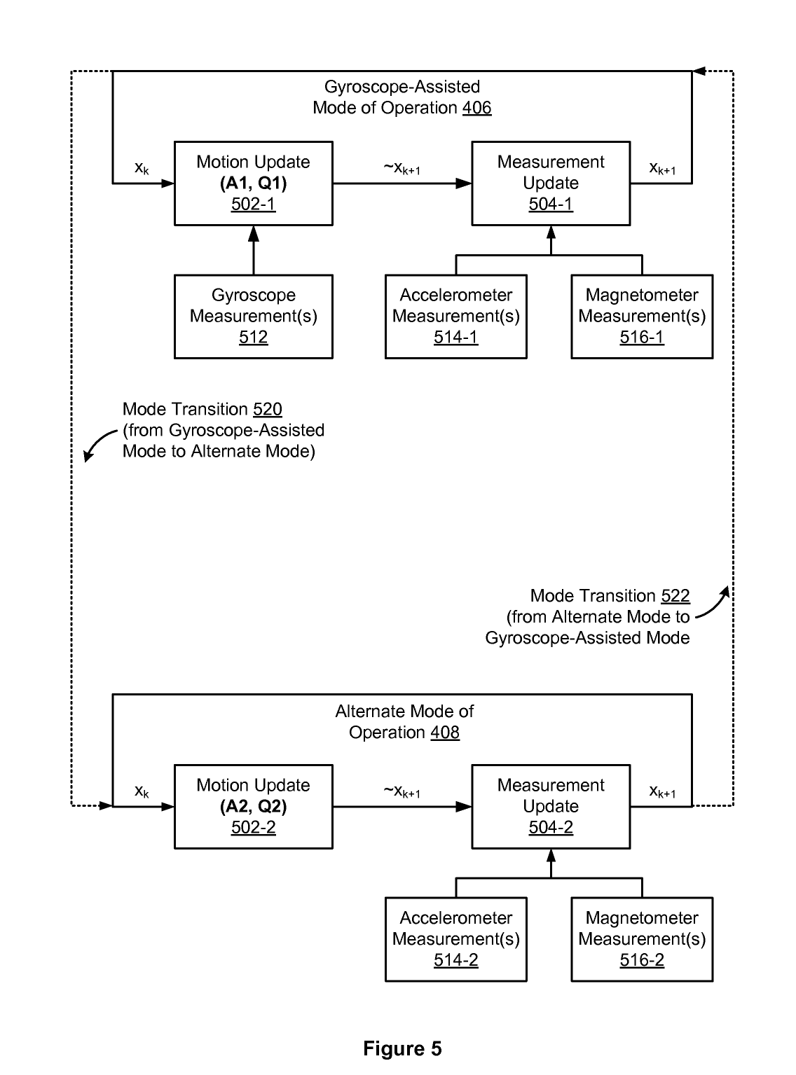

FIG. 5 shows examples of using sensor measurements to update an estimate of a navigational state of a navigation device. In particular, FIG. 5 illustrates an example of an iterative navigational state estimate generation process during Gyroscope-Assisted Mode of Operation 406 of the processing apparatus and also illustrates an example of an iterative navigational state estimate generation process during Alternate Mode of Operation 408 of the processing apparatus. In the iterative navigation state estimation process a current state xₖ at time k is updated based on Motion Update 502 and Measurement Update 504 to generate a next state xₖ₊₁. Motion Update 502 takes Gyroscope Measurements 512, if available, as inputs. Measurement Update 504 takes Accelerometer Measurements 514 and Magnetometer Measurements 516 as inputs.

For example, the state is given by: xₖ=[gₖ w_{b,k} γₖ], where gₖ is the gibbs attitude vector, w_{b,k} is the gyroscope bias vector, and γₖ is the estimated error in the “GH angle” which is herein defined as “the angle between the gravity vector and the reference magnetic field vector (e.g., the Earth's magnetic field).” In some embodiments, the current state xₖ is processed in accordance with Motion Update 502 to generate an intermediate state ˜xₖ₊₁ and the intermediate state ˜xₖ₊₁ is processed in accordance with Measurement Update 504 to generate the next state xₖ₊₁. In some implementations the same iterative process is used during Gyroscope-Assisted Mode of Operation 406 and Alternate Mode of Operation 408, with an adjusted sensor model (e.g., adjusted state transition values and process noise covariance values). Using a same iterative process with an adjusted sensor model makes transitioning between Gyroscope-Assisted Mode of Operation 406 and Alternate Mode of Operation 408 easier, as the processing apparatus can switch between the two modes of operation (e.g., Mode Transition 520 or Mode Transition 522) by switching sensor models (e.g., switching state transition values and process noise covariance values).

In some embodiments, a primary difference between Gyroscope-Assisted Mode of Operation 406 and Alternate Mode of Operation 408 is in the implementation of Motion Update 502. In Gyroscope-Assisted Mode of Operation 406 the motion update consists of the following state and covariance update equations: xₖ₊₁=Axₖ+zₖ Δt; Pₖ₊₁=APₖA^{T}+Q. In these equations, A is the state transition matrix; xₖ is the state at time k; zₖΔt is a term corresponding to a predicted change in orientation of Device 102 generated by combining a value zₖ corresponding to a gyroscope measurement with a time step Δt corresponding to a time between k and k+1; Pₖ is the state covariance at time k; and Q is the system process noise covariance. In Alternate Mode of Operation 408 the motion update consists of the following state and covariance update equations: xₖ₊₁=Axₖ; Pₖ₊₁=APₖA^{T}+Q. In these equations, A is the state transition matrix; xₖ is the state at time k; Pₖ is the state covariance at time k; and Q is the system process noise covariance.

In some implementations, Q is a diagonal matrix with a main diagonal that includes seven terms, the first three terms are “attitude terms” corresponding to process noise for attitude error covariance (e.g., yaw, pitch and roll) based on accelerometer and magnetometer measurements; the next three terms are “gyroscope terms” corresponding to process noise for gyroscope offset bias error covariance; and the last term is a “GH-angle term” corresponding to process noise for GH angle covariance. The magnitude of terms in Q affects the magnitude of change that the Kalman filter can introduce between two successive estimates of navigational state of Device 102. If the gyroscope terms have a greater magnitude than the attitude terms, then gyroscope measurements will have a larger effect on estimated navigational state Device 102 than sensor measurements from the accelerometer (s) and magnetometer(s). If the gyroscope terms have a lower magnitude than the attitude terms, then gyroscope measurements will have a smaller effect on estimated navigational state of Device 102 than sensor measurements from the accelerometer (s) and magnetometer(s). Additionally, if the total magnitude (e.g., a sum or average) of the terms is increased or decreased, then the responsiveness of the Kalman filter to movement of Device 102 will be changed accordingly. If the total magnitude of the terms is increased, the Kalman filter will be more responsive (e.g., a change detected by the sensors will have an increased effect on the estimated navigational state). If the total magnitude of the terms is decreased, the Kalman filter will be less responsive (e.g., a change detected by the sensors will have a smaller effect on the estimated navigational state). Thus, if one or more of the terms are reduced substantially, other terms would need to be increased accordingly to keep the Kalman filter at a predefined level of responsiveness to movement of Device 102.

During Gyroscope-Assisted Mode of Operation 406 of the processing apparatus, a state xₖ at time k is updated based on Gyroscope Measurements 512 using Motion Update 502-1 that includes a first state transition matrix A1 and a first system process noise covariance Q1 to produce an intermediate state ˜xₖ₊₁. In one example the first state transition matrix is defined as

$$A 1 = {I}_{7} + [ \begin{matrix}{0}_{3 \times 3} & {I}_{3} & 0 \\ {0}_{4 \times 3} & {0}_{4 \times 3} & {0}_{4 \times 1}\end{matrix} ] ,$$

where I₇ is a 7×7 identity matrix, I₃ is a 3×3 identity matrix, and 0_{n×m} is a n(row)×m(column) null matrix. In one example the first system process noise covariance is defined as Q1, in which the attitude terms generally have a smaller magnitude than the gyroscope terms. In this example, the attitude terms have a smaller magnitude than the gyroscope terms because the gyroscope measurements are trusted more than the attitude measurements generated by the accelerometer and magnetometer and thus the noise covariance terms corresponding to the gyroscope are larger, so as to allow the Kalman filter to make larger adjustments in estimated navigational state based on a revised attitude estimate based on gyroscope measurements as compared with an adjustment that would be made based on a similarly revised attitude estimate based on accelerometer and magnetometer measurements. The intermediate state ˜xₖ₊₁ is updated based on Accelerometer Measurements 514-1 and Magnetometer Measurements 516-1 using Measurement Update 504-1 to produce an updated state xₖ₊₁.

In contrast, during Alternate Mode of Operation 408 of the processing apparatus, a state xₖ at time k is updated using Motion Update 502-2 that includes a second state transition matrix A2 and a second system process noise covariance Q2 to produce an intermediate state ˜xₖ₊₁. In one example, the second state transition matrix is defined as A2=I₇, where I₇ is a 7×7 identity matrix. In this example, the system process noise covariance is defined as Q2, in which the gyroscope terms are reduced substantially (e.g., set to zero), because the gyroscope is not providing measurements. Additionally, in some implementations, the attitude terms in Q2 have a larger magnitude than the attitude terms in Q1, so that the Kalman filter can introduce the same total magnitude of change in between two states in the Alternate Mode of Operation 408 as it was able to in Gyroscope-Assisted Mode of Operation, even though the gyroscope terms have been reduced substantially (e.g., set to zero). The intermediate state ˜xₖ₊₁ is updated based on Accelerometer Measurements 514-2 and Magnetometer Measurements 516-2 using Measurement Update 504-2 to produce an updated state xₖ₊₁.

In the example shown in FIG. 5, the primary difference between the iterative navigational state estimate generation process in Gyroscope-Assisted Mode of Operation 406 and the iterative navigational state estimate generation in Alternate Mode of Operation 408 is the difference in the state transition matrix A and the system process noise covariance Q. As such, in this example, the processing apparatus can switch between Gyroscope-Assisted Mode of Operation 406 and Alternate Mode of Operation 408 simply by modifying the state transition matrix and the process noise covariance in the iterative navigational state estimation process. Moreover, this enables a smooth transition, as the iterative process can keep running continuously and the state transition matrix and the process noise covariance can be switched when the processing apparatus is ready to transition to between the two modes depending on whether or not gyroscope sensor measurements are available. Additionally, this means that output of iterative navigational state estimate generation processes in both modes are compatible with each other. Consequently, even if the current state xₖ was generated in Gyroscope-Assisted Mode of Operation 406, the state transition matrix can be switched from A1 to A2 and the process noise covariance can be switched from Q1 to Q2 and the resulting next state xₖ₊₁ will be generated in the Alternate Mode of Operation 408 (e.g., Mode Transition 520) using Motion Update 502-2 (which, optionally, does not include a zₖΔt term, as described above). Likewise, even if the current state xₖ was generated in Alternate Mode of Operation 408, the state transition matrix can be switched from A2 to A1 and the process noise covariance can be switched from Q2 to Q1 and the resulting next state xₖ₊₁ will be generated in the Gyroscope-Assisted Mode of Operation 406 (e.g., Mode Transition 522) using Motion Update 502-1 (which, optionally, includes a zₖΔt term, as described above).

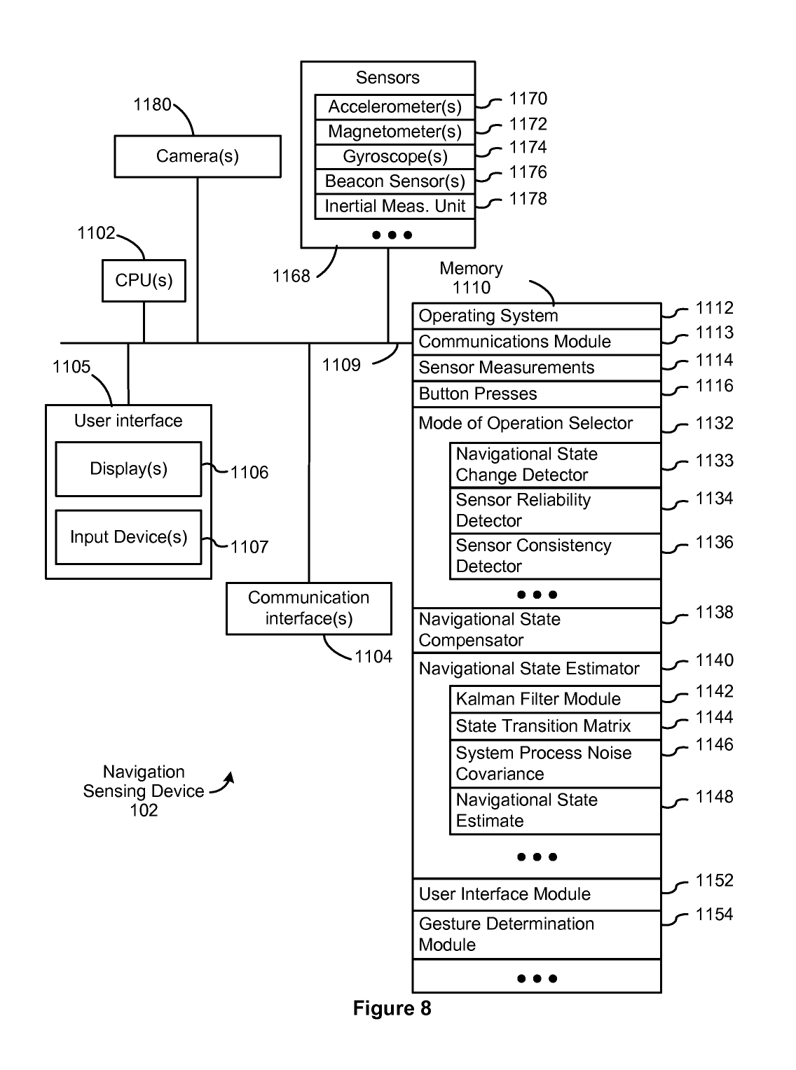

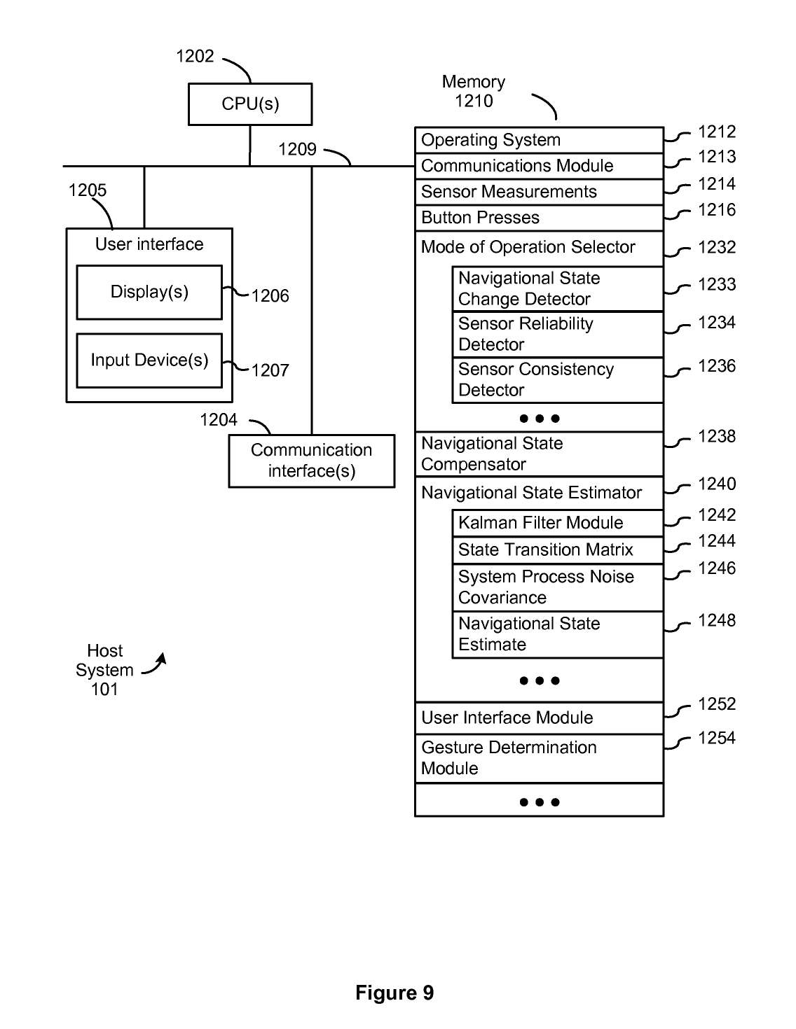

Attention is now directed to FIGS. 6A-6C, which illustrate a method 600 for determining estimated navigational states of a navigation sensing device. Method 600 is, optionally, governed by instructions that are stored in a non-transitory computer readable storage medium and that are executed by one or more processors of one or more computer systems (e.g., Device 102, FIG. 8 or Host 101, FIG. 9). Each of the operations shown in FIGS. 6A-6C typically corresponds to instructions stored in a computer memory or non-transitory computer readable storage medium (e.g., Memory 1110 of Device 102 in FIG. 8 or Memory 1210 of Host 101 in FIG. 9). The computer readable storage medium optionally (and typically) includes a magnetic or optical disk storage device, solid state storage devices such as Flash memory, or other non-volatile memory device or devices. The computer readable instructions stored on the computer readable storage medium typically include one or more of: source code, assembly language code, object code, or other instruction format that is interpreted or executed by one or more processors. In various embodiments, some operations in method 600 are combined and/or the order of some operations is changed from the order shown in FIGS. 6A-6C.

The following operations are performed at a processing apparatus having one or more processors and memory storing one or more programs that when executed by the one or more processors cause the respective processing apparatus to perform the method. In some embodiments, the processing apparatus is a component of Device 102 (e.g., the processing apparatus includes CPU(s) 1102 in FIG. 8). In some embodiments, the processing apparatus is separate from Device 102 (e.g., the processing apparatus includes CPU(s) 1202 in FIG. 9).

The processing apparatus generates (602) navigational state estimates for a device (e.g., Device 102) having a plurality of sensors. The plurality of sensors includes a gyroscope and the processing apparatus has a plurality of modes of operation including a gyroscope-assisted mode of operation (e.g., Gyroscope-Assisted Mode of Operation 406 in FIGS. 4A-4B, 5) in which measurements from the gyroscope are used to estimate the navigational state of Device 102 and an alternate mode of operation (e.g., Alternate Mode of Operation 408 in FIGS. 4A-4B, 5) in which measurements from a subset of sensors of the plurality of sensors that does not include the gyroscope are used to estimate the navigational state of Device 102.

In some embodiments, a Kalman filter is used (604) to estimate navigational states of Device 102, where the Kalman filter includes a state equation including a state transition matrix and a state covariance equation including the state transition matrix and a system noise covariance component. In some embodiments, in the gyroscope-assisted mode of operation, the Kalman filter uses a first state transition matrix (e.g., A1 in FIG. 5) and a first system noise covariance component (e.g., Q1 in FIG. 5) and in the alternate mode of operation the Kalman filter uses a second state transition matrix (e.g., A2 in FIG. 5) different from the first state transition matrix and a second system noise covariance component (e.g., Q2 in FIG. 5) different from the first system noise covariance component.

In some embodiments the processing apparatus operates (606) in the gyroscope-assisted mode of operation. While operating in the gyroscope-assisted mode of operation, the processing apparatus determines (608) whether predetermined criteria have been met. In some embodiments, the predetermined criteria include (610) a determination that Device 102 has remained stationary for more than a predefined time period (e.g., determining that Device 102 is still in accordance with stillness criteria). In some embodiments, the predetermined criteria include (612) a determination that the subset of sensors that does not include the gyroscope includes sensors that provide sensor measurements that enable the estimate of the navigational state of Device 102 to be accurately updated (e.g., a determination that Device 102 is not subject to an uncompensated magnetic disturbance). In accordance with a determination that predetermined criteria have not (614) been met the processing apparatus remains in the gyroscope-assisted mode of operation to the alternate mode of operation. In contrast, in accordance with a determination that the predetermined criteria have (616) been met, the processing apparatus transitions (618) from the gyroscope-assisted mode of operation to the alternate mode of operation. For example, the gyroscope is put into a low power mode when Device 102 is still (e.g., moving less than a predefined amount) and measurements from other sensors (e.g., a magnetometer and accelerometer) will be able to temporarily determine changes in navigational state of Device 102 when Device 102 begins moving again.

For a first time period and a subsequent transition time period, the processing apparatus operates (620) in the alternate mode of operation using measurements from a subset of sensors of the plurality of sensors that does not include the gyroscope to estimate the navigational state of Device 102. In some embodiments, using measurements from the subset of sensors, that does not include the gyroscope, to estimate the navigational state of Device 102 includes collecting (622) a plurality of sets of measurements from one or more sensors of the plurality of sensors other than the gyroscope (e.g., a multi-dimensional magnetometer and one or more multi-dimensional accelerometers) and using (624) the plurality of sets of measurements to estimate the navigational state of Device 102.

In some embodiments, during (626) the first period of time, the gyroscope is in the low-power state. In some implementations, the low-power state of the gyroscope is (628) an off state. In some implementations, the low-power state of the gyroscope is (630) a reduced-functionality state. For example, some gyroscopes have at least three different states: an off state where the gyroscope draws a minimum amount of power and provides no functionality, a reduced-functionality state where the gyroscope draws an amount of power greater than the minimum amount of power but still less than a measurement-generation amount of power and does not generate gyroscope measurements, and a measurement-generation state where the gyroscope draws at least the measurement-generation amount of power and generates gyroscope measurements. In some situations the amount of power drawn by the gyroscope will depend on the current operation of Device 102 including what applications are running on Device 102 or the processing apparatus and the current movement of Device 102.

In some embodiments, while the gyroscope is in the low-power state, the processing apparatus determines whether an updated estimate of the navigational state of Device 102 is needed and in response to determining that (632) the updated estimate of the navigational state of Device 102 is not needed, the processing apparatus leaves the gyroscope in the low-power state. However, in response to determining that (634) the updated estimate of the navigational state of Device 102 is needed, the processing apparatus starts (636) to transition the gyroscope from the low-power state to the measurement-generation state (e.g., preparing to use the gyroscope to determine the navigational state of Device 102). In some implementations, the gyroscope transitions from the low-power state to the measurement-generation state during the transition time period.

At an end of the transition time period, the processing apparatus starts (638) to use measurements from the gyroscope to estimate the navigational state of Device 102. Many gyroscopes take (640) at least a minimum amount of time to transition from a low-power state (e.g., a reduced-functionality state or an off state) to a measurement-generation state. Thus, in some embodiments, the end of the transition time period corresponds to a time at which the gyroscope has transitioned to the measurement-generation state.

In some embodiments, estimating the navigational state of Device 102 includes using (642) an iterative estimation process to generate a next estimate of the navigational state of Device 102 based on a corresponding current estimate of the navigational state of Device 102 (e.g., as described above in greater detail with reference to FIG. 5). In some implementations, while operating in the alternate mode of operation, current estimates and corresponding next estimates are generated by the iterative estimation process based on measurements from the subset of sensors of the plurality of sensors that does not include the gyroscope (e.g., one or more magnetometers and one or more accelerometers). In contrast, while operating in the gyroscope-assisted mode of operation, current estimates and corresponding next estimates are generated by the iterative estimation process based on measurements from the gyroscope and, optionally, one or more magnetometers and one or more accelerometers. In these implementations, starting to use measurements from the gyroscope to estimate the navigational state of Device 102 includes using a respective current estimate of the navigational state of Device 102 generated based on measurements of the subset of sensors of the plurality of sensors that does not include the gyroscope in conjunction with measurements from the gyroscope to generate a respective next estimate of the navigational state of Device 102. For example, in FIG. 5, Mode Transition 522 from Alternate Mode of Operation 408 to Gyroscope-Assisted Mode of Operation 406 includes using xₖ from Alternate Mode of Operation 408 to generate xₖ₊₁ in Gyroscope Assisted Mode of Operation 406.

For a second time period, which occurs after the transition time period, the processing apparatus operates (644) in the gyroscope-assisted mode of operation using measurements of the plurality of sensors, including the gyroscope, to estimate the navigational state of Device 102. In other words, after the processing apparatus has transitioned to the gyroscope-assisted mode of operation measurements from a plurality of sensors (e.g., one or more magnetometers, one or more accelerometers and the gyroscope) are used to determine changes in navigational state of Device 102. In some embodiments, the gyroscope-assisted mode of operation is a normal more of operation for the processing apparatus and the alternate mode of operation is a special mode that is used to conserve power. In other embodiments, the alternate mode of operation is a normal mode of operation for the processing apparatus and the gyroscope-assisted mode of operation is used in situations where high fidelity navigational state estimates are needed.

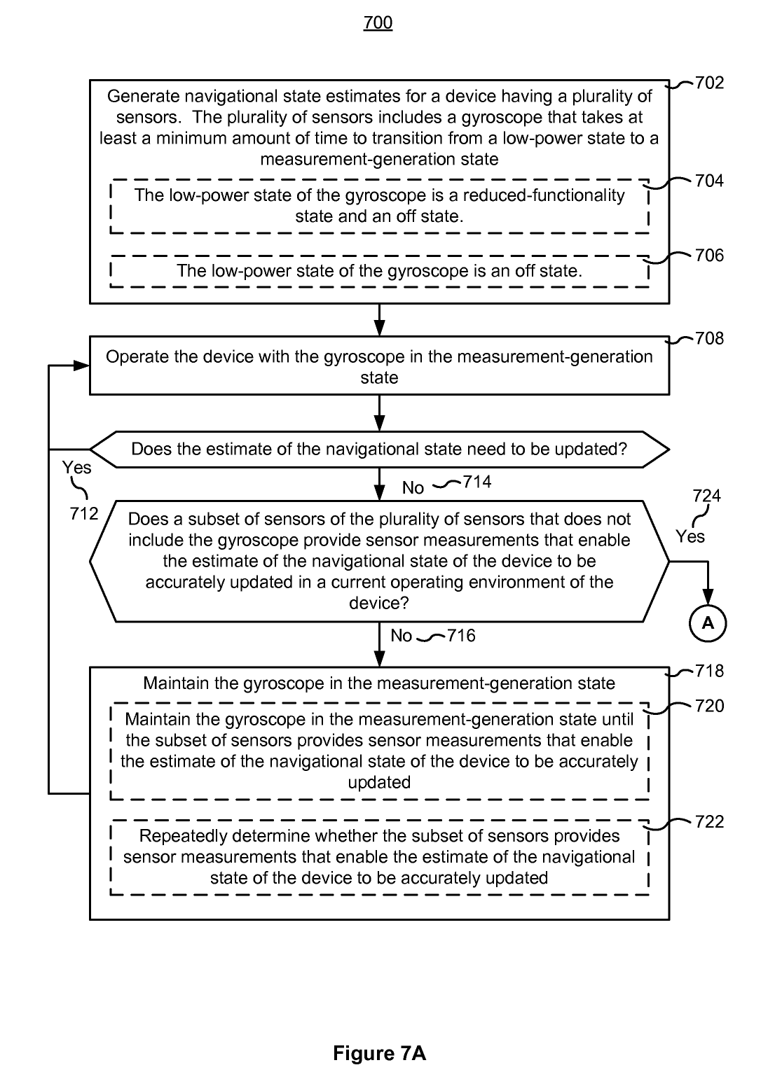

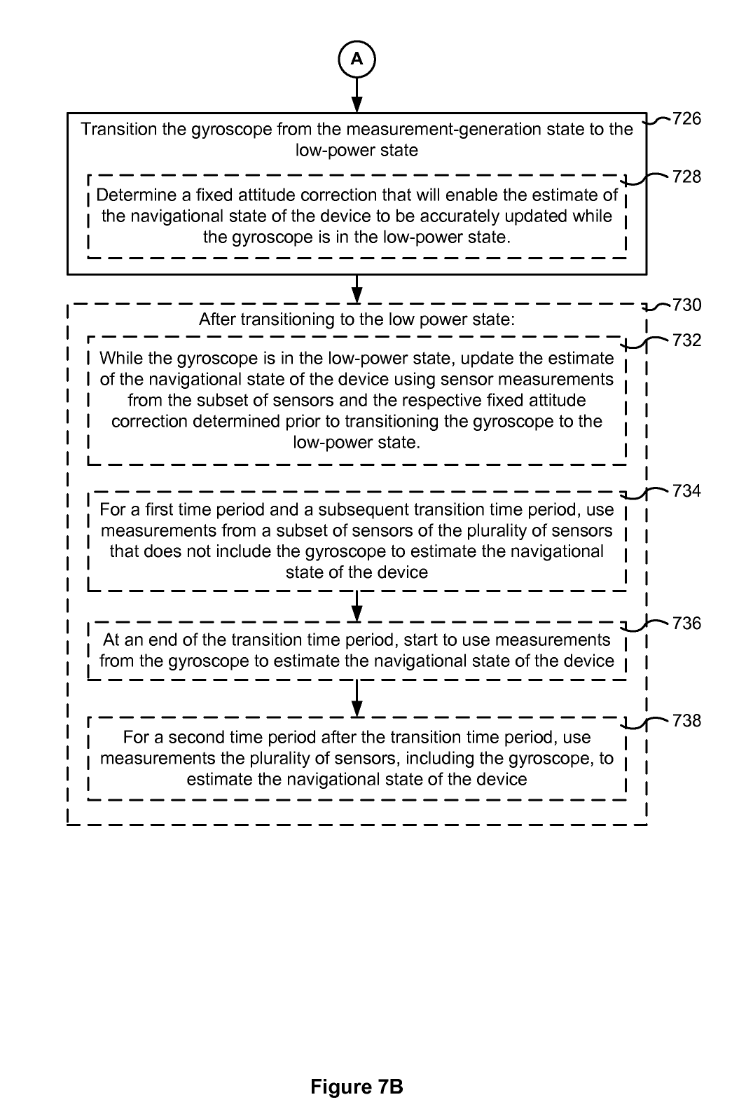

It should be understood that the particular order in which the operations in FIGS. 6A-6C have been described are merely exemplary and are not intended to indicate that the described order is the only order in which the operations could be performed. One of ordinary skill in the art would recognize various ways to reorder the operations described herein. Additionally, it should be noted that details of other processes described herein with respect to method 700 (e.g., FIGS. 7A-7B) are also applicable in an analogous manner to method 600 described above with respect to FIGS. 6A-6C. For example, the sensors, sensor measurements and navigational state estimation operations described above with reference to method 600 may have one or more of the characteristics of the various the sensors, sensor measurements and navigational state estimation operations described herein with reference to method 700. For brevity, these details are not repeated here.

Attention is now directed to FIGS. 7A-7B, which illustrate a method 700 for determining estimated navigational states of a navigation sensing device. Method 700 is, optionally, governed by instructions that are stored in a non-transitory computer readable storage medium and that are executed by one or more processors of one or more computer systems (e.g., Device 102, FIG. 8 or Host 101, FIG. 9). Each of the operations shown in FIGS. 7A-7B typically corresponds to instructions stored in a computer memory or non-transitory computer readable storage medium (e.g., Memory 1110 of Device 102 in FIG. 8 or Memory 1210 of Host 101 in FIG. 9). The computer readable storage medium optionally (and typically) includes a magnetic or optical disk storage device, solid state storage devices such as Flash memory, or other non-volatile memory device or devices. The computer readable instructions stored on the computer readable storage medium typically include one or more of: source code, assembly language code, object code, or other instruction format that is interpreted or executed by one or more processors. In various embodiments, some operations in method 700 are combined and/or the order of some operations is changed from the order shown in FIGS. 7A-7B.

The following operations are performed at a processing apparatus having one or more processors and memory storing one or more programs that when executed by the one or more processors cause the respective processing apparatus to perform the method. In some embodiments, the processing apparatus is a component of Device 102 (e.g., the processing apparatus includes CPU(s) 1102 in FIG. 8). In some embodiments, the processing apparatus is separate from Device 102 (e.g., the processing apparatus includes CPU(s) 1202 in FIG. 9).

The processing apparatus generates (702) navigational state estimates for a device (e.g., Device 102) having a plurality of sensors. The plurality of sensors includes a gyroscope that takes at least a minimum amount of time to transition from a low-power state to a measurement-generation state. For example certain types of MEMS (microelectromechanical systems) gyroscopes take up to 250 ms to warm up from a low-power state to a measurement-generation state. In some embodiments, the low-power state of the gyroscope is (704) a reduced-functionality state. In some embodiments, the low-power state of the gyroscope is (706) an off state.

The processing apparatus operates (708) Device 102 with the gyroscope in the measurement-generation state. While the gyroscope is in the measurement-generation state, the processing apparatus determines whether the estimate of the navigational state of Device 102 needs to be updated. In accordance with a determination that the estimate of the navigational state of Device 102 needs (712) to be updated (e.g., because Device 102 is in motion or has recently been in motion, as determined based on sensor measurements of one or more of the sensors in Device 102), the processing apparatus keeps the gyroscope in the measurement-generation state (e.g., by continuing to request sensor measurements from the gyroscope or by forgoing providing instructions to the gyroscope to enter a low-power state).

In contrast, after determining that the estimate of the navigational state of Device 102 does not need to be updated (e.g., because Device 102 is at rest), the processing apparatus determines whether a subset of sensors of the plurality of sensors that does not include the gyroscope provides measurements that enable the estimate of the navigational state of Device 102 to be accurately updated in a current operating environment of Device 102. For example, the processing apparatus determines whether there is an uncompensated magnetic disturbance (e.g., a non-uniform magnetic disturbance) that would make magnetometer measurements unreliable and/or whether Device 102 is undergoing linear acceleration that would make accelerometer measurements unreliable.

In accordance with a determination that the subset of sensors does not (716) provide sensor measurements that enable the estimate of the navigational state of Device 102 in the current operating environment of Device 102, the processing apparatus maintains (718) the gyroscope in the measurement-generation state. In some embodiments, maintaining the gyroscope in the measurement-generation state comprises maintaining (720) the gyroscope in the measurement-generation state until the subset of sensors provides sensor measurements that enable the estimate of the navigational state of Device 102 to be accurately updated (e.g., due to a change in the current operating environment to an operating environment that does not distort magnetometer measurements). In some embodiments, maintaining the gyroscope in the measurement-generation state comprises repeatedly (722) determining whether the subset of sensors provides sensor measurements that enable the estimate of the navigational state of Device 102 to be accurately updated. Thus, in some embodiments the processing apparatus keeps the gyroscope in the measurement-generation state even though the navigational state of Device 102 does not need to be updated for as long as Device 102 remains in the current operating environment, so that the navigational state estimate will not be distorted by the conditions of the current operating environment that make other sensors of Device 102 unreliable when the navigational state of Device 102 begins to change again.

In contrast, in accordance with a determination that the subset of sensors provides (724) measurements that enable the estimate of the navigational state of Device 102 to be accurately updated in the current operating environment of Device 102 (e.g., that there is no uncompensated magnetic disturbance or linear acceleration), the processing apparatus transitions (726) the gyroscope from the measurement-generation state to the low-power state. In some embodiments, as part of transitioning the gyroscope from the measurement-generation state to the low-power state the processing apparatus determines (728) a fixed attitude correction that will enable the estimate of the navigational state of Device 102 to be accurately updated while the gyroscope is in the low-power state.

In some implementations, determining whether the subset of sensors provides sensor measurements that enable the estimate of the navigational state of Device 102 to be accurately updated in the current operating environment of Device 102 includes determining whether the subset of sensors provides sensor measurements that enable the estimate of the navigational state of Device 102 to be accurately updated in conjunction with a fixed attitude correction. For example, a magnetometer and an accelerometer will provide sensor measurements that enable an estimate of a navigational state of a device to be accurately updated when the detected magnetic field is locally uniform, even though it deviates from the reference magnetic field (e.g., the Earth's magnetic field), provided that an offset between the local magnetic field and the rotational magnetic field is known.

Such uniform changes to the local magnetic field can be caused by changes in configuration of Device 102. For example, when Device 102 is put down on a table/surface that distorts the magnetic field. Since Device 102 is stationary for a period of time after it is set down, the distortion is constant and so the difference between the new external field and the reference magnetic field (e.g., the Earth's magnetic field) can be well described by a fixed orientation offset. Another situation is when a known change in device configuration of Device 102 occurs, such as when Device 102 is placed in a charging dock, a lid of Device 102 is opened, or, for a convertible laptop (a notebook computer that can have its lid detached and used as a tablet) when the tablet component is docked/undocked from the keyboard. These changes in device configuration are predefined (known in advance) and thus the magnetic disturbance caused in each case can be well characterized in advance. Consequently, the magnetic disturbance caused by these predefined changes in device configuration can be modeled in advance as modifications to the sensor model (e.g., a known orientation offset or a model of well-known non-uniform magnetic disturbance components) that compensate for the magnetic disturbance, and used when the known magnetic disturbance is detected.

In some embodiments, in accordance with a determination that the subset of sensors provides sensor measurements that enable the estimate of the navigational state to be accurately updated in conjunction with a fixed attitude correction, prior to transitioning the gyroscope to the low-power state the processing apparatus determines a respective fixed attitude correction, as described in greater detail above. After the respective fixed attitude correction is determined, the processing apparatus transitions the gyroscope to the low-power state. Subsequently, while the gyroscope is in the low-power state, the processing apparatus updates (732) the estimate of the navigational state of Device 102 using sensor measurements from the subset of sensors and the respective fixed attitude correction.

In some embodiments, the gyroscope takes at least a minimum amount of time to transition from a low-power state to a measurement-generation state, as described in greater detail above. In some of these embodiments, for a first time period and a subsequent transition time period, the processing apparatus uses (734) measurements from a subset of sensors of the plurality of sensors that does not include the gyroscope to estimate the navigational state of Device 102, and at an end of the transition time period the processing apparatus starts (736) to use measurements from the gyroscope to estimate the navigational state of Device 102. In these embodiments, for a second time period, which occurs after the transition time period, the processing apparatus uses (738) measurements from the plurality of sensors, including the gyroscope, to estimate the navigational state of Device 102. Implementations directed to transitioning from a mode in which the gyroscope is in a low-power state to a mode in which the gyroscope is in a measurement-generation state are described in greater detail above with reference to FIGS. 6A-6C.

It should be understood that the particular order in which the operations in FIGS. 7A-7B have been described are merely exemplary and are not intended to indicate that the described order is the only order in which the operations could be performed. One of ordinary skill in the art would recognize various ways to reorder the operations described herein. Additionally, it should be noted that details of other processes described herein with respect to method 600 (e.g., FIGS. 6A-6C) are also applicable in an analogous manner to method 700 described above with respect to FIGS. 7A-7B. For example, the sensors, sensor measurements and navigational state estimation operations described above with reference to method 700 may have one or more of the characteristics of the various sensors, sensor measurements and navigational state estimation operations described herein with reference to method 600. For brevity, these details are not repeated here.

### System Structure

FIG. 8 is a block diagram of Navigation Sensing Device 102 (herein “Device 102”). Device 102 typically includes one or more processing units (CPUs) 1102, one or more network or other Communications Interfaces 1104 (e.g., a wireless communication interface, as described above with reference to FIG. 1), Memory 1110, Sensors 1168 (e.g., Sensors 220 such as one or more Accelerometers 1170, Magnetometers 1172, Gyroscopes 1174, Beacon Sensors 1176, Inertial Measurement Units 1178, Thermometers, Barometers, and/or Proximity Sensors, etc.), one or more Cameras 1180, and one or more Communication Buses 1109 for interconnecting these components. In some embodiments, Communications Interfaces 1104 include a transmitter for transmitting information, such as accelerometer and magnetometer measurements, and/or the computed navigational state of Device 102, and/or other information to Host 101. Communication buses 1109 typically include circuitry (sometimes called a chipset) that interconnects and controls communications between system components. Device 102 optionally includes user interface 1105 comprising Display 1106 (e.g., Display 104 in FIG. 1) and Input Devices 1107 (e.g., keypads, buttons, etc.). Memory 1110 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1110 optionally includes one or more storage devices remotely located from the CPU(s) 1102. Memory 1110, or alternately the non-volatile memory device(s) within Memory 1110, comprises a non-transitory computer readable storage medium. In some embodiments, Memory 1110 stores the following programs, modules and data structures, or a subset thereof:
Operating System 1112 that includes procedures for handling various basic system services and for performing hardware dependent tasks;
Communication Module 1113 that is used for connecting Device 102 to Host 101 via Communication Network Interface(s) 1104 (wired or wireless); Communication Module 1113 is optionally adapted for connecting Device 102 to one or more communication networks, such as the Internet, other wide area networks, local area networks, metropolitan area networks, and so on;
Sensor Measurements 1114 (e.g., data representing accelerometer measurements, magnetometer measurements, gyroscope measurements, global positioning system measurements, beacon sensor measurements, inertial measurement unit measurements, thermometer measurements, atmospheric pressure measurements, proximity measurements, etc.);
data representing Button Presses 1116;
Mode of Operation Selector 1132, for selecting a mode of operation for the processing apparatus (e.g., Gyroscope-Assisted Mode of Operation 406 or Alternate Mode of Operation in FIGS. 4A-4B, 5), which optionally includes:
   Navigational State Change Detector 1133 for determining whether the Device 102 is in motion and thus whether an updated navigational state estimate is needed for Device 102, and, if so, causing the processing apparatus to transition the gyroscope to a measurement-generation state;
   Sensor Reliability Detector 1134 for detecting conditions under which sensor measurements from particular sensors are no longer reliable (e.g., detecting disturbances in the local magnetic field of Device 102 such as sudden changes in magnetic field direction that do not correspond to changes in navigational state of Device 102 and/or detecting that the local magnetic field is non-uniform; or detecting liner acceleration that would make accelerometer measurements unreliable), and if sensors measurements are not reliable forgoing transitioning the gyroscope to a low-power state; and
   Sensor Consistency Detector 1136 for determining whether sensors are reliable again (e.g., determining magnetometer measurements are consistent with other sensor measurements and/or whether magnetometer measurements are consistent with each other, indicating that Device 102 is in a uniform magnetic field), and if sensors are reliable again and Device is not in motion, transitioning the gyroscope to the low-power mode;
Navigational State Compensator 1138 for determining a fixed compensation (e.g., a rotational offset) for compensating for drift in the navigational state estimate while the processing apparatus was in the alternate mode of operation or using a modified sensor model to compensate for a known magnetic disturbance;
Navigation State Estimator 1140 for estimating navigational states of Device 102, optionally including:
   Kalman Filter Module 1142 that determines the attitude of Device 102, as described in U.S. Pat. Pub. No. 2010/0174506 Equations 8-29, wherein the Kalman filter module includes: a sensor model (e.g., the sensor model described in Equations 28-29 of U.S. Pat. Pub. No. 2010/0174506), a dynamics model (e.g., the dynamics model described in Equations 15-21 of U.S. Pat. Pub. No. 2010/0174506), a predict module that performs the predict phase operations of the Kalman filter, an update module that performs the update operations of the Kalman filter, a state vector of the Kalman filter (e.g., the state vector \hat{x} in Equation 10 of U.S. Pat. Pub. No. 2010/0174506), a mapping, Kalman filter matrices, and attitude estimates (e.g., the attitude estimates as obtained from the quaternion in the state vector \hat{x} in Equation 10 of U.S. Pat. Pub. No. 2010/0174506);
   State Transition Matrix 1144 (e.g., A, as described in greater detail above with reference to FIG. 5);
   System Process Noise Covariance 1146 (e.g., Q, as described in greater detail above with reference to FIG. 5);
   data representing Navigational State Estimate 1148 (e.g., an estimate of the position and/or attitude of Device 102).
optionally, User Interface Module 1152 that receives commands from the user via Input Device(s) 1107 and generates user interface objects in Display(s) 1106 in accordance with the commands and the navigational state of Device 102, User Interface Module 1152 optionally includes one or more of: a cursor position module for determining a cursor position for a cursor to be displayed in a user interface in accordance with changes in a navigational state of the navigation sensing device, an augmented reality module for determining positions of one or more user interface objects to be displayed overlaying a dynamic background such as a camera output in accordance with changes in a navigational state of the navigation sensing device, a virtual world module for determining a portion of a larger user interface (a portion of a virtual world) to be displayed in accordance with changes in a navigational state of the navigation sensing device, a pedestrian dead reckoning module for tracking movement of Device 102 over time, and other application specific user interface modules; and
optionally, Gesture Determination Module 1154 for determining gestures in accordance with detected changes in the navigational state of Device 102.

It is noted that in some of the embodiments described above, Device 102 does not include a Gesture Determination Module 1154, because gesture determination is performed by Host 101. In some embodiments described above, Device 102 also does not include Mode of Operation Selector 1132, Navigational State Estimator 1140 and User Interface Module, because Device 102 transmits Sensor Measurements 1114 and, optionally, data representing Button Presses 1116 to a Host 101 at which a navigational state of Device 102 is determined.

Each of the above identified elements may be stored in one or more of the previously mentioned memory devices, and each of the above identified programs or modules corresponds to a set of instructions for performing a function described above. The set of instructions can be executed by one or more processors (e.g., CPUs 1102). The above identified modules or programs (i.e., sets of instructions) need not be implemented as separate software programs, procedures or modules, and thus various subsets of these modules may be combined or otherwise re-arranged in various embodiments. In some embodiments, Memory 1110 may store a subset of the modules and data structures identified above. Furthermore, Memory 1110 may store additional modules and data structures not described above.

Although FIG. 8 shows a “Navigation Sensing Device 102,” FIG. 8 is intended more as functional description of the various features which may be present in a navigation sensing device. In practice, and as recognized by those of ordinary skill in the art, items shown separately could be combined and some items could be separated.

FIG. 9 is a block diagram of Host Computer System 101 (herein “Host 101”). Host 101 typically includes one or more processing units (CPUs) 1202, one or more network or other Communications Interfaces 1204 (e.g., any of the wireless interfaces described above with reference to FIG. 1), Memory 1210, and one or more Communication Buses 1209 for interconnecting these components. In some embodiments, Communication Interfaces 1204 include a receiver for receiving information, such as accelerometer and magnetometer measurements, and/or the computed attitude of a navigation sensing device (e.g., Device 102), and/or other information from Device 102. Communication Buses 1209 optionally include circuitry (sometimes called a chipset) that interconnects and controls communications between system components. Host 101 optionally includes a User Interface 1205 comprising a Display 1206 (e.g., Display 104 in FIG. 1) and Input Devices 1207 (e.g., a navigation sensing device such as a multi-dimensional pointer, a mouse, a keyboard, a trackpad, a trackball, a keypad, buttons, etc.). Memory 1210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1210 optionally includes one or more storage devices remotely located from the CPU(s) 1202. Memory 1210, or alternately the non-volatile memory device(s) within Memory 1210, comprises a non-transitory computer readable storage medium. In some embodiments, Memory 1210 stores the following programs, modules and data structures, or a subset thereof:
Operating System 1212 that includes procedures for handling various basic system services and for performing hardware dependent tasks;
Communication Module 1213 that is used for connecting Host 101 to Device 102, and/or other devices or systems via Communication Network Interface(s) 1204 (wired or wireless), and for connecting Host 101 to one or more communication networks, such as the Internet, other wide area networks, local area networks, metropolitan area networks, and so on;
Sensor Measurements 1214 (e.g., data representing accelerometer measurements, magnetometer measurements, gyroscope measurements, global positioning system measurements, beacon sensor measurements, inertial measurement unit measurements, thermometer measurements, atmospheric pressure measurements, proximity measurements, etc.);
data representing Button Presses 1216;
Mode of Operation Selector 1232, for selecting a mode of operation for the processing apparatus (e.g., Gyroscope-Assisted Mode of Operation 406 or Alternate Mode of Operation in FIGS. 4A-4B, 5), which optionally includes:
   Navigational State Change Detector 1233 for determining whether the Device 102 is in motion and thus whether an updated navigational state estimate is needed for Device 102, and, if so, causing the processing apparatus to transition the gyroscope to a measurement-generation state;
   Sensor Reliability Detector 1234 for detecting conditions under which sensor measurements from particular sensors are no longer reliable (e.g., detecting disturbances in the local magnetic field of Device 102 such as sudden changes in magnetic field direction that do not correspond to changes in navigational state of Device 102 and/or detecting that the local magnetic field is non-uniform; or detecting liner acceleration that would make accelerometer measurements unreliable), and if sensors measurements are not reliable forgoing transitioning the gyroscope to a low-power state; and
   Sensor Consistency Detector 1236 for determining whether sensors are reliable again (e.g., determining magnetometer measurements are consistent with other sensor measurements and/or whether magnetometer measurements are consistent with each other, indicating that Device 102 is in a uniform magnetic field), and if sensors are reliable again and Device is not in motion, transitioning the gyroscope to the low-power mode;
Navigational State Compensator 1238 for determining a fixed compensation (e.g., a rotational offset) for compensating for drift in the navigational state estimate while the processing apparatus was in the alternate mode of operation or using a modified sensor model to compensate for a known magnetic disturbance;
Navigation State Estimator 1240 for estimating navigational states of Device 102, optionally including:
   Kalman Filter Module 1242 that determines the attitude of Device 102, as described in U.S. Pat. Pub. No. 2010/0174506 Equations 8-29, wherein the Kalman filter module includes: a sensor model (e.g., the sensor model described in Equations 28-29 of U.S. Pat. Pub. No. 2010/0174506), a dynamics model (e.g., the dynamics model described in Equations 15-21 of U.S. Pat. Pub. No. 2010/0174506), a predict module that performs the predict phase operations of the Kalman filter, an update module that performs the update operations of the Kalman filter, a state vector of the Kalman filter (e.g., the state vector \hat{x} in Equation 10 of U.S. Pat. Pub. No. 2010/0174506), a mapping, Kalman filter matrices, and attitude estimates (e.g., the attitude estimates as obtained from the quaternion in the state vector \hat{x} in Equation 10 of U.S. Pat. Pub. No. 2010/0174506);
   State Transition Matrix 1244 (e.g., A, as described in greater detail above with reference to FIG. 5);
   System Process Noise Covariance 1246 (e.g., Q, as described in greater detail above with reference to FIG. 5);
   data representing Navigational State Estimate 1248 (e.g., an estimate of the position and/or attitude of Device 102).
optionally, User Interface Module 1252 that receives commands from the user via Input Device(s) 1207 and generates user interface objects in Display(s) 1206 in accordance with the commands and the navigational state of Device 102, User Interface Module 1252 optionally includes one or more of: a cursor position module for determining a cursor position for a cursor to be displayed in a user interface in accordance with changes in a navigational state of the navigation sensing device, an augmented reality module for determining positions of one or more user interface objects to be displayed overlaying a dynamic background such as a camera output in accordance with changes in a navigational state of the navigation sensing device, a virtual world module for determining a portion of a larger user interface (a portion of a virtual world) to be displayed in accordance with changes in a navigational state of the navigation sensing device, a pedestrian dead reckoning module for tracking movement of Device 102 over time, and other application specific user interface modules; and
optionally, Gesture Determination Module 1254 for determining gestures in accordance with detected changes in the navigational state of Device 102.

It is noted that in some of the embodiments described above, Host 101 does not store data representing Sensor Measurements 1214, because sensor measurements of Device 102 are processed at Device 102, which sends data representing Navigational State Estimate 1248 to Host 101. In other embodiments, Device 102 sends data representing Sensor Measurements 1214 to Host 101, in which case the modules for processing that data are present in Host 101.

Each of the above identified elements may be stored in one or more of the previously mentioned memory devices, and each of the above identified programs or modules corresponds to a set of instructions for performing a function described above. The set of instructions can be executed by one or more processors (e.g., CPUs 1202). The above identified modules or programs (i.e., sets of instructions) need not be implemented as separate software programs, procedures or modules, and thus various subsets of these modules may be combined or otherwise re-arranged in various embodiments. The actual number of processors and software modules used to implement Host 101 and how features are allocated among them will vary from one implementation to another. In some embodiments, Memory 1210 may store a subset of the modules and data structures identified above. Furthermore, Memory 1210 may store additional modules and data structures not described above.

Note that methods 600 and 700 described above are optionally governed by instructions that are stored in a non-transitory computer readable storage medium and that are executed by one or more processors of Device 102 or Host 101. As noted above, in some embodiments these methods may be performed in part on Device 102 and in part on Host 101, or on a single integrated system which performs all the necessary operations. Each of the operations shown in FIGS. 6A-6C and 7A-7B optionally correspond to instructions stored in a computer memory or computer readable storage medium. The computer readable storage medium optionally includes a magnetic or optical disk storage device, solid state storage devices such as Flash memory, or other non-volatile memory device or devices. In some embodiments, the computer readable instructions stored on the computer readable storage medium are in source code, assembly language code, object code, or other instruction format that is interpreted by one or more processors.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method comprising:
at a processing apparatus having one or more processors and memory storing one or more programs that when executed by the one or more processors cause the respective processing apparatus to perform the method:
generating navigational state estimates for a device having a plurality of sensors, wherein the plurality of sensors includes a gyroscope, wherein the processing apparatus has a plurality of modes of operation including:
a gyroscope-assisted mode of operation in which measurements from the gyroscope are used to estimate the navigational state of the device; and
an alternate mode of operation in which measurements from a subset of sensors of the plurality of sensors that does not include the gyroscope are used to estimate the navigational state of the device;
for a first time period and a subsequent transition time period, operating in the alternate mode of operation using measurements from a subset of sensors of the plurality of sensors that does not include the gyroscope to estimate the navigational state of the device;
at an end of the transition time period, starting to use measurements from the gyroscope to estimate the navigational state of the device; and
for a second time period, after the transition time period, operating in the gyroscope-assisted mode of operation using measurements the plurality of sensors, including the gyroscope, to estimate the navigational state of the device.

2. The method of claim 1, wherein the processing apparatus is a component of the device.

3. The method of claim 1, wherein:
the gyroscope takes at least a minimum amount of time to transition from a low-power state to a measurement-generation state; and
the end of the transition time period corresponds to a time at which the gyroscope has transitioned to the measurement-generation state.

4. The method of claim 3, wherein the low-power state of the gyroscope is selected from the set consisting of: a reduced-functionality state and an off state.

5. The method of claim 3, wherein:
during the first period of time, the gyroscope is in the low-power state; and
the method further comprises:
while the gyroscope is in the low-power state, determining that an updated estimate of the navigational state of the device is needed; and
in response to determining that the updated estimate of the navigational state of the device is needed, starting to transition the gyroscope from the low-power state to the measurement-generation state, wherein the gyroscope transitions from the low-power state to the measurement-generation state during the transition time period.

6. The method of claim 1, wherein using measurements from the subset of sensors, that does not include the gyroscope, to estimate the navigational state of the device includes:
collecting a plurality of sets of measurements from one or more sensors of the plurality of sensors other than the gyroscope; and
using the plurality of sets of measurements to estimate the navigational state of the device.

7. The method of claim 1, wherein a Kalman filter is used to estimate navigational states of the device, the Kalman filter includes:
a state equation including a state transition matrix; and
a state covariance equation including the state transition matrix and a system noise covariance component;
in the gyroscope-assisted mode of operation, the Kalman filter uses a first state transition matrix and a first system noise covariance component; and
in the alternate mode of operation the Kalman filter uses a second state transition matrix different from the first state transition matrix and a second system noise covariance component different from the first system noise covariance component.

8. The method of claim 1, wherein:
estimating the navigational state of the device includes using an iterative estimation process to generate a next estimate of the navigational state of the device based on a corresponding current estimate of the navigational state of the device;
while operating in the alternate mode of operation, current estimates and corresponding next estimates are generated by the iterative estimation process based on measurements from the subset of sensors of the plurality of sensors that does not include the gyroscope;
while operating in the gyroscope-assisted mode of operation, current estimates and corresponding next estimates are generated by the iterative estimation process based on measurements from the gyroscope; and
starting to use measurements from the gyroscope to estimate the navigational state of the device includes using a respective current estimate of the navigational state of the device generated based on measurements of the subset of sensors of the plurality of sensors that does not include the gyroscope in conjunction with measurements from the gyroscope to generate a respective next estimate of the navigational state of the device.

9. The method of claim 1, further comprising, prior to the first time period transitioning from the gyroscope-assisted mode of operation to the alternate mode of operation in response to determining that predetermined criteria have been met.

10. The method of claim 9, wherein the predetermined criteria include a determination that the device has remained stationary for more than a predefined time period.

11. The method of claim 9, wherein the predetermined criteria include a determination that the subset of sensors that does not include the gyroscope includes sensors that provide sensor measurements that enable the estimate of the navigational state of the device to be accurately updated.

12. A computer system, comprising:
a processing apparatus including one or more processors and memory; and
one or more programs, wherein the one or more programs are stored in the memory and configured to be executed by the one or more processors, the one or more programs including instructions for:
generating navigational state estimates for a device having a plurality of sensors, wherein the plurality of sensors includes a gyroscope, wherein the processing apparatus has a plurality of modes of operation including:
a gyroscope-assisted mode of operation in which measurements from the gyroscope are used to estimate the navigational state of the device; and
an alternate mode of operation in which measurements from a subset of sensors of the plurality of sensors that does not include the gyroscope are used to estimate the navigational state of the device;
for a first time period and a subsequent transition time period, operating in the alternate mode of operation using measurements from a subset of sensors of the plurality of sensors that does not include the gyroscope to estimate the navigational state of the device;
at an end of the transition time period, starting to use measurements from the gyroscope to estimate the navigational state of the device; and
for a second time period, after the transition time period, operating in the gyroscope-assisted mode of operation using measurements the plurality of sensors, including the gyroscope, to estimate the navigational state of the device.

13. The computer system of claim 12, wherein:
the gyroscope takes at least a minimum amount of time to transition from a low-power state to a measurement-generation state; and
the end of the transition time period corresponds to a time at which the gyroscope has transitioned to the measurement-generation state.

14. The computer system of claim 13, wherein:
during the first period of time, the gyroscope is in the low-power state; and
the one or more programs include instructions for:
while the gyroscope is in the low-power state, determining that an updated estimate of the navigational state of the device is needed; and
in response to determining that the updated estimate of the navigational state of the device is needed, starting to transition the gyroscope from the low-power state to the measurement-generation state, wherein the gyroscope transitions from the low-power state to the measurement-generation state during the transition time period.

15. The computer system of claim 12, wherein using measurements from the subset of sensors, that does not include the gyroscope, to estimate the navigational state of the device includes:
collecting a plurality of sets of measurements from one or more sensors of the plurality of sensors other than the gyroscope; and
using the plurality of sets of measurements to estimate the navigational state of the device.

16. The computer system of claim 12, wherein:
estimating the navigational state of the device includes using an iterative estimation process to generate a next estimate of the navigational state of the device based on a corresponding current estimate of the navigational state of the device;
while operating in the alternate mode of operation, current estimates and corresponding next estimates are generated by the iterative estimation process based on measurements from the subset of sensors of the plurality of sensors that does not include the gyroscope;
while operating in the gyroscope-assisted mode of operation, current estimates and corresponding next estimates are generated by the iterative estimation process based on measurements from the gyroscope; and
starting to use measurements from the gyroscope to estimate the navigational state of the device includes using a respective current estimate of the navigational state of the device generated based on measurements of the subset of sensors of the plurality of sensors that does not include the gyroscope in conjunction with measurements from the gyroscope to generate a respective next estimate of the navigational state of the device.

17. A non-transitory computer readable storage medium storing one or more programs, the one or more programs comprising instructions, which when executed by a processing apparatus with one or more processors, cause the processing apparatus to:
generate navigational state estimates for a device having a plurality of sensors, wherein the plurality of sensors includes a gyroscope, wherein the processing apparatus has a plurality of modes of operation including:
a gyroscope-assisted mode of operation in which measurements from the gyroscope are used to estimate the navigational state of the device; and
an alternate mode of operation in which measurements from a subset of sensors of the plurality of sensors that does not include the gyroscope are used to estimate the navigational state of the device;
for a first time period and a subsequent transition time period, operate in the alternate mode of operation using measurements from a subset of sensors of the plurality of sensors that does not include the gyroscope to estimate the navigational state of the device;
at an end of the transition time period, start to use measurements from the gyroscope to estimate the navigational state of the device; and
for a second time period, after the transition time period, operate in the gyroscope-assisted mode of operation using measurements the plurality of sensors, including the gyroscope, to estimate the navigational state of the device.

18. The non-transitory computer readable storage medium of claim 17, wherein:
the gyroscope takes at least a minimum amount of time to transition from a low-power state to a measurement-generation state; and
the end of the transition time period corresponds to a time at which the gyroscope has transitioned to the measurement-generation state.

19. The non-transitory computer readable storage medium of claim 18, wherein:
during the first period of time, the gyroscope is in the low-power state; and
the one or more programs include instructions to:
while the gyroscope is in the low-power state, determining that an updated estimate of the navigational state of the device is needed; and
in response to determining that the updated estimate of the navigational state of the device is needed, starting to transition the gyroscope from the low-power state to the measurement-generation state, wherein the gyroscope transitions from the low-power state to the measurement-generation state during the transition time period.

20. The non-transitory computer readable storage medium of claim 17, wherein using measurements from the subset of sensors, that does not include the gyroscope, to estimate the navigational state of the device includes:
collecting a plurality of sets of measurements from one or more sensors of the plurality of sensors other than the gyroscope; and
using the plurality of sets of measurements to estimate the navigational state of the device.

21. The non-transitory computer readable storage medium of claim 17, wherein:
estimating the navigational state of the device includes using an iterative estimation process to generate a next estimate of the navigational state of the device based on a corresponding current estimate of the navigational state of the device;
while operating in the alternate mode of operation, current estimates and corresponding next estimates are generated by the iterative estimation process based on measurements from the subset of sensors of the plurality of sensors that does not include the gyroscope;
while operating in the gyroscope-assisted mode of operation, current estimates and corresponding next estimates are generated by the iterative estimation process based on measurements from the gyroscope; and
starting to use measurements from the gyroscope to estimate the navigational state of the device includes using a respective current estimate of the navigational state of the device generated based on measurements of the subset of sensors of the plurality of sensors that does not include the gyroscope in conjunction with measurements from the gyroscope to generate a respective next estimate of the navigational state of the device.
